(19) United States
(12) Patent Application Publication
(10) Pub. No.: US 2019/0200011 A1
(43) Pub. Date: Jun. 27, 2019

(54) INTRA-PREDICTION MODE-BASED IMAGE PROCESSING METHOD AND APPARATUS THEREFOR

(71) Applicant: LG ELECTRONICS INC., Seoul (KR)

(72) Inventors: Sunmi YOO, Seoul (KR); Jin HEO, Seoul (KR)

(21) Appl. No.: 16/331,497

(22) PCT Filed: Sep. 8, 2016
(86) PCT No.: PCT/KR2016/010124

§ 371 Date: Mar. 7, 2019

(51) Int. Cl. H04N 19/105; H04N 19/176; H04N 19/82; H04N 19/159

(52) U.S. Cl. CPC H04N 19/105; H04N 19/159; H04N 19/82; H04N 19/176

(57) ABSTRACT

Disclosed are an intra-prediction mode-based image processing method and an apparatus therefor. Particularly, the intra-prediction mode-based image processing method may comprise the steps of: generating a predicted sample of a current block on the basis of an intra-prediction mode of the current block; calculating the distance between the predicted sample and a first reference sample used to generate the predicted sample; and when the distance between the predicted sample and the first reference sample is larger than a filtering reference value, filtering the predicted sample by a weighted addition of the predicted sample and a second reference sample, wherein, among reference samples adjacent to the current block, at least one of a reference sample having the same horizontal coordinate component as the predicted sample and a reference sample having the same vertical coordinate component as the predicted sample is used as the second reference sample.

### CROSS-REFERENCE TO RELATED APPLICATIONS

This application is the National Stage filing under 35 U.S.C. 371 of International Application No. PCT/KR2016/010124, filed on Sep. 8, 2016 and the contents of which are all hereby incorporated by reference herein in their entirety.

### TECHNICAL FIELD

The present invention relates to a still image or moving image processing method and, more particularly, to a method of encoding/decoding a still image or moving image based on an intra-prediction mode and an apparatus supporting the same.

### BACKGROUND ART

A compression encoding means a series of signal processing techniques for transmitting digitized information through a communication line or techniques for storing the information in a form that is proper for a storage medium. The media including a picture, an image, an audio, and the like may be the target for the compression encoding, and particularly, the technique of performing the compression encoding targeted to the picture is referred to as a video image compression.

The next generation video contents are supposed to have the characteristics of high spatial resolution, high frame rate and high dimensionality of scene representation. In order to process such contents, drastic increase of memory storage, memory access rate and processing power will be resulted.

Accordingly, it is required to design the coding tool for processing the next generation video contents efficiently.

### DISCLOSURE

### Technical Problem

In the existing intra-prediction (or intra-frame prediction) method, when a prediction sample is generated, a pixel value of a reference pixel is duplicated based on the direction of an intra-prediction mode. Accordingly, each pixel within a prediction block may have a different distance from the reference pixel depending on the position of the pixel. When the distance between the predicted pixel and the reference pixel becomes distant, the accuracy of prediction may be reduced compared to a pixel whose difference does not become distant from the reference pixel.

In order to solve the problem, an object of the present invention proposes a method of filtering a reference sample close to the position of a prediction sample when the distance between the prediction sample and the reference sample is greater than a given distance.

Furthermore, an object of the present invention proposes a filtering method in which a case where reference is made to multiple reference sample lines has been taken into consideration.

Technical objects to be achieved in the present invention are not limited to the aforementioned object, and those skilled in the art to which the present invention pertains may evidently understand other technological objects from the following description.

### Technical Solution

In an aspect of the present invention, a method of processing video based on an intra-prediction mode may include generating a prediction sample of a current block based on an intra-prediction mode of a current block; calculating a distance between the prediction sample and a first reference sample used to generate the prediction sample; and performing filtering on the prediction sample by weighted-summing at least one of a sample having same vertical coordinates as the prediction sample and a sample having same horizontal coordinates as the prediction sample, among reference samples neighboring the current block, and the prediction sample as a second reference sample when the distance between the prediction sample and the first reference sample is greater than a filtering criterion value.

In an aspect of the present invention, an apparatus for processing video based on an intra-prediction mode may include a prediction sample generation unit configured to generate a prediction sample of a current block based on an intra-prediction mode of a current block; an inter-sample distance calculation unit configured to calculate a distance between the prediction sample and a first reference sample used to generate the prediction sample; and a filtering unit configured to perform filtering on the prediction sample by weighted-summing at least one of a sample having same vertical coordinates as the prediction sample and a sample having same horizontal coordinates as the prediction sample, among reference samples neighboring the current block, and the prediction sample as a second reference sample when the distance between the prediction sample and the first reference sample is greater than a filtering criterion value.

Preferably, when the current block is a square block, the filtering criterion value may be set to a value obtained by adding an offset of a predetermined size to a width value of the current block.

Preferably, when the current block is a non-square block, the filtering criterion value may be set to a value obtained by adding an offset of a predetermined size to a greater value among a width and height of the current block.

Preferably, when the current block is a non-square block, the filtering criterion value may be set to a value obtained by adding an offset of a predetermined size to a smaller value among a width and height of the current block.

Preferably, when the current block is a non-square block, the filtering criterion value may be set to a value obtained by adding an offset of a predetermined size to a value determined according to a size of the current block and the intra-prediction mode, among a width and height of the current block.

Preferably, a sample positioned in a distance closer to the prediction sample, among the sample having the same vertical coordinates as the prediction sample and the sample having the same horizontal coordinates as the prediction sample, may be determined as a second reference sample.

Preferably, the filtering may be performed by applying, to the second reference sample, a weight based on a distance between the prediction sample and the second reference sample.

Preferably, the distance between the prediction sample and the first reference sample may be calculated using an angle of the intra-prediction mode and the vertical coordinates or horizontal coordinates of the prediction sample.

Preferably, when the direction of the intra-prediction mode is a negative angle direction, the distance between the prediction sample and the first reference sample may be calculated based on the first reference sample positioned in a reference sample array neighboring the top or left of the current block.

Preferably, the distance between the prediction sample and the first reference sample may be derived from a predetermined distance between the prediction sample and the reference sample based on the size of the current block and the intra-prediction mode.

Preferably, when reference is made to multiple reference sample lines in order to generate the prediction sample of the current block, the filtering may be performed using a second reference sample positioned in a reference sample line most neighboring the current block.

Preferably, when reference is made to multiple reference sample lines in order to generate the prediction sample of the current block, the filtering may be performed using a second reference sample positioned in a reference sample line used to generate the prediction sample or a reference sample line more neighboring the current block than the reference sample line used to generate the prediction sample.

Preferably, when reference is made to multiple reference sample lines in order to generate the prediction sample of the current block, a reference sample line in which the second reference sample used for the filtering is positioned may be transmitted from an encoder.

### Advantageous Effects

In accordance with an embodiment of the present invention, the accuracy of prediction can be enhanced by applying filtering to a predicted pixel based on the distance between the predicted pixel and a reference pixel.

Furthermore, in accordance with an embodiment of the present invention, a distance from a reference pixel used for filtering can be reduced and prediction performance can be enhanced by selecting a reference sample line used for the filtering if reference is made to multiple reference sample lines.

Effects which may be obtained in the present invention are not limited to the aforementioned effects, and various other effects may be evidently understood by those skilled in the art to which the present invention pertains from the following description.

### DESCRIPTION OF DRAWINGS

The accompanying drawings, which are included herein as a part of the description for help understanding the present invention, provide embodiments of the present invention, and describe the technical features of the present invention with the description below.

FIG. 1 is an embodiment to which the present invention is applied, and shows a schematic block diagram of an encoder in which the encoding of a still image or moving image signal is performed.

FIG. 2 is an embodiment to which the present invention is applied, and shows a schematic block diagram of a decoder in which the encoding of a still image or moving image signal is performed.

FIG. 3 is a diagram for illustrating the split structure of a coding unit to which the present invention may be applied.

FIG. 4 is a diagram for illustrating a prediction unit to which the present invention may be applied.

FIG. 5 is an embodiment to which the present invention is applied and is a diagram illustrating an intra-prediction method.

FIG. 6 illustrates prediction directions according to intra-prediction modes.

FIG. 7 is a diagram for illustrating the distance between a prediction sample and a reference sample according to an intra-prediction direction.

FIG. 8 is a diagram for illustrating a method of calculating a distance from a reference sample according to an embodiment of the present invention.

FIG. 9 is a diagram for illustrating a method of calculating a distance from a reference sample according to an embodiment of the present invention.

FIG. 10 is a diagram for illustrating a method of calculating a distance from a reference sample according to an embodiment of the present invention.

FIG. 11 is a diagram for illustrating a method of calculating a distance from a reference sample according to an embodiment of the present invention.

FIG. 12 is a diagram illustrating an intra-prediction method according to an embodiment of the present invention.

FIG. 13 is a diagram for illustrating the distance between a prediction sample and a reference sample according to an intra-prediction direction.

FIG. 14 is a diagram illustrating an intra-prediction method according to an embodiment of the present invention.

FIG. 15 is an embodiment to which the present invention may be applied and illustrates a filtering method when multiple reference samples are used.

FIG. 16 is a diagram illustrating an intra-prediction method according to an embodiment of the present invention.

FIG. 17 is a detailed diagram illustrating an intra-prediction unit according to an embodiment of the present invention.

### MODE FOR INVENTION

Hereinafter, preferred embodiments of the present invention will be described by reference to the accompanying drawings. The description that will be described below with the accompanying drawings is to describe exemplary embodiments of the present invention, and is not intended to describe the only embodiment in which the present invention may be implemented. The description below includes particular details in order to provide perfect understanding of the present invention. However, it is understood that the present invention may be embodied without the particular details to those skilled in the art.

In some cases, in order to prevent the technical concept of the present invention from being unclear, structures or devices which are publicly known may be omitted, or may be depicted as a block diagram centering on the core functions of the structures or the devices.

Further, although general terms widely used currently are selected as the terms in the present invention as much as possible, a term that is arbitrarily selected by the applicant is used in a specific case. Since the meaning of the term will be clearly described in the corresponding part of the description in such a case, it is understood that the present invention will not be simply interpreted by the terms only used in the description of the present invention, but the meaning of the terms should be figured out.

Specific terminologies used in the description below may be provided to help the understanding of the present invention. Furthermore, the specific terminology may be modified into other forms within the scope of the technical concept of the present invention. For example, a signal, data, a sample, a picture, a frame, a block, etc may be properly replaced and interpreted in each coding process.

Hereinafter, in this specification, a “processing unit” means a unit by which an encoding/decoding processing process, such as prediction, transform and/or quantization, is performed. Hereinafter, for convenience of description, a processing unit may also be called a “processing block” or “block.”

A processing unit may be construed as a meaning including a unit for a luma component and a unit for a chroma component. For example, a processing unit may correspond to a coding tree unit (CTU), a coding unit (CU), a prediction unit (PU) or a transform unit (TU).

Furthermore, a processing unit may be construed as a unit for a luma component or a unit for a chroma component. For example, a processing unit may correspond to a coding tree block (CTB), coding block (CB), prediction block (PB) or transform block (TB) for a luma component. Alternatively, a processing unit may correspond to a coding tree block (CTB), coding block (CB), prediction block (PB) or transform block (TB) for a chroma component. Furthermore, the present invention is not limited thereto, and a processing unit may be construed as a meaning including a unit for a luma component and a unit for a chroma component.

Furthermore, a processing unit is not essentially limited to a block of a square, but may have a polygon form having three or more vertexes.

Furthermore, hereinafter, in this specification, a pixel or pixel element is collected referred to as a sample. Furthermore, using a sample may mean using a pixel value or a pixel element value.

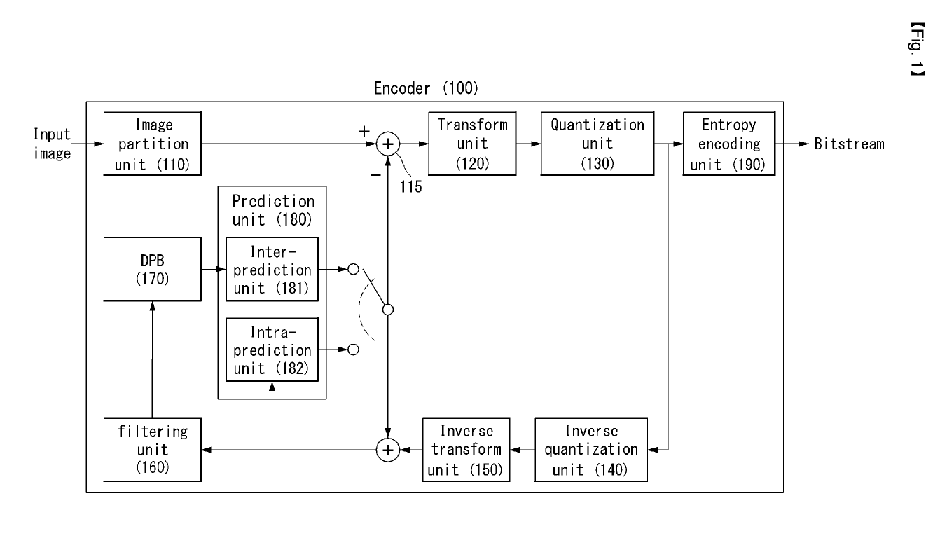

FIG. 1 is an embodiment to which the present invention is applied, and shows a schematic block diagram of an encoder in which the encoding of a still image or moving image signal is performed.

Referring to FIG. 1, an encoder 100 may include a picture split unit 110, a subtraction unit 115, a transform unit 120, a quantization unit 130, a dequantization unit 140, an inverse transform unit 150, a filtering unit 160, a decoded picture buffer (DPB) 170, a prediction unit 180 and an entropy encoding unit 190. Furthermore, the prediction unit 180 may include an inter-prediction unit 181 and an intra-prediction unit 182.

The video split unit 110 splits an input video signal (or picture or frame), input to the encoder 100, into one or more processing units.

The subtractor 115 generates a residual signal (or residual block) by subtracting a prediction signal (or prediction block), output by the prediction unit 180 (i.e., inter-prediction unit 181 or intra-prediction unit 182), from the input video signal. The generated residual signal (or residual block) is transmitted to the transform unit 120.

The transform unit 120 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transform unit 120 may generate the transform coefficients by performing transform using a determined transform scheme depending on a prediction mode applied to the residual block and the size of the residual block.

The quantization unit 130 quantizes the transform coefficient and transmits it to the entropy encoding unit 190, and the entropy encoding unit 190 performs an entropy coding operation of the quantized signal and outputs it as a bit stream.

Meanwhile, the quantized signal that is outputted from the quantization unit 130 may be used for generating a prediction signal. For example, by applying dequantization and inverse transform to the quantized signal through the dequantization unit 140 and the inverse transform unit 150, the residual signal may be reconstructed. By adding the reconstructed residual signal to the prediction signal that is outputted from the inter-prediction unit 181 or the intra-prediction unit 182, a reconstructed signal may be generated.

Meanwhile, during such a compression process, adjacent blocks are quantized by different quantization parameters from each other, and accordingly, an artifact in which block boundaries are shown may occur. Such a phenomenon is referred to blocking artifact, which is one of the important factors for evaluating image quality. In order to decrease such an artifact, a filtering process may be performed. Through such a filtering process, the blocking artifact is removed and the error for the current picture is decreased at the same time, thereby the image quality being improved.

The filtering unit 160 applies filtering to the reconstructed signal, and outputs it through a play-back device or transmits it to the decoded picture buffer 170. The filtered signal transmitted to the decoded picture buffer 170 may be used as a reference picture in the inter-prediction unit 181. As such, by using the filtered picture as a reference picture in an inter-picture prediction mode, the encoding rate as well as the image quality may be improved.

The decoded picture buffer 170 may store the filtered picture in order to use it as a reference picture in the inter-prediction unit 181.

The inter-prediction unit 181 performs a temporal prediction and/or a spatial prediction by referencing the reconstructed picture in order to remove a temporal redundancy and/or a spatial redundancy. In this case, since the reference picture used for performing a prediction is a transformed signal that goes through the quantization or the dequantization by a unit of block when being encoded/decoded previously, there may exist blocking artifact or ringing artifact.

Accordingly, in order to solve the performance degradation owing to the discontinuity of such a signal or the quantization, by applying a low pass filter to the inter-prediction unit 181, the signals between pixels may be interpolated by a unit of sub-pixel. Herein, the sub-pixel means a virtual pixel that is generated by applying an interpolation filter, and an integer pixel means an actual pixel that is existed in the reconstructed picture. As a method of interpolation, a linear interpolation, a bi-linear interpolation, a wiener filter, and the like may be applied.

The interpolation filter may be applied to the reconstructed picture, and may improve the accuracy of prediction. For example, the inter-prediction unit 181 may perform prediction by generating an interpolation pixel by applying the interpolation filter to the integer pixel, and by using the interpolated block that includes interpolated pixels as a prediction block.

The intra-prediction unit 182 predicts the current block by referring to the samples adjacent the block that is to be encoded currently. The intra-prediction unit 182 may perform the following procedure in order to perform the intra-prediction. First, the intra-prediction unit 182 may prepare a reference sample that is required for generating a prediction signal. Furthermore, the intra-prediction unit 182 may generate a prediction signal by using the reference sample prepared. After, the intra-prediction unit 182 may encode the prediction mode. In this case, the reference sample may be prepared through reference sample padding and/or reference sample filtering. Since the reference sample goes through the prediction and the reconstruction process, there may be a quantization error. Accordingly, in order to decrease such an error, the reference sample filtering process may be performed for each prediction mode that is used for the intra-prediction.

Specifically, the intra-prediction unit 182 according to the present invention may perform filtering on a reference sample close to the position of a predicted pixel within a current block when the distance between the predicted pixel and a reference pixel is greater than a given distance. The intra-prediction unit 182 is described more specifically later.

The prediction signal (or prediction block) generated through the inter-prediction unit 181 or the intra-prediction unit 182 may be used to generate a reconstructed signal (or reconstructed block) or may be used to generate a residual signal (or residual block).

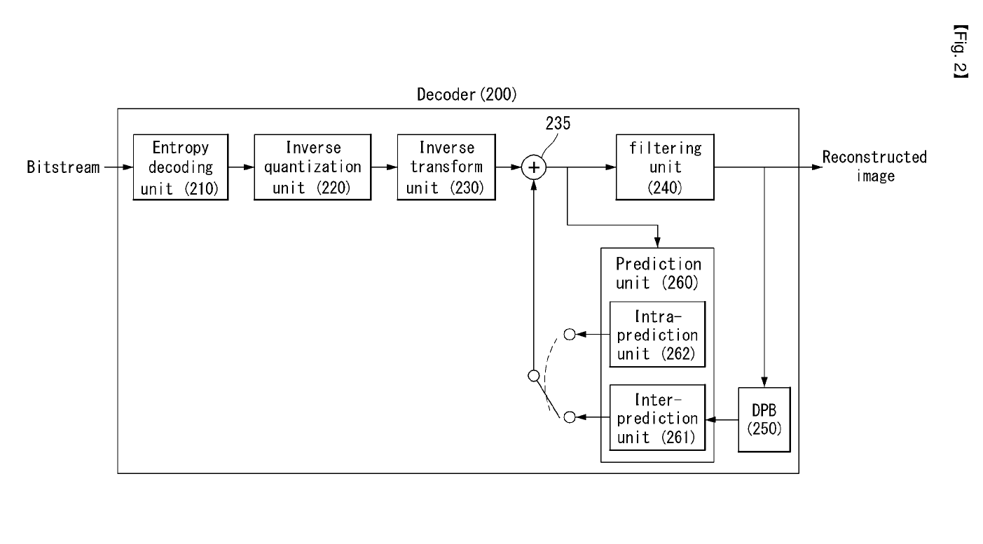

FIG. 2 is an embodiment to which the present invention is applied and shows a schematic block diagram of a decoder in which the encoding of a still image or moving image signal is performed.

Referring to FIG. 2, the decoder 200 may be configured to include an entropy decoding unit 210, a dequantization unit 220, an inverse transform unit 230, an adder 235, a filtering unit 240, a decoded picture buffer unit (DPB) 250, a prediction unit 260. Furthermore, the prediction unit 260 may be configured to include an inter-prediction unit 261 and an intra-prediction unit 262.

Furthermore, a reconstructed video signal output through the decoder 200 may be played back through a playback device.

The decoder 200 receives a signal (i.e., bit stream) output by the encoder 100 of FIG. 1. The received signal is entropy-decoded through the entropy decoding unit 210.

The dequantization unit 220 obtains a transform coefficient from the entropy-decoded signal using quantization step size information.

The inverse transform unit 230 obtains a residual signal (or residual block) by applying an inverse transform scheme to inverse-transform the transform coefficient.

The adder 235 adds the obtained residual signal (or residual block) to a prediction signal (or prediction block), output from the prediction unit 260 (i.e., inter-prediction unit 261 or intra-prediction unit 262), thereby generating a reconstructed signal (or reconstructed block).

The filtering unit 240 applies filtering to the reconstructed signal (or reconstructed block) and outputs the filtered signal to a playback device or transmits it to the decoded picture buffer unit 250. The filtered signal transmitted to the decoded picture buffer unit 250 may be used as a reference picture in the inter-prediction unit 261.

In this specification, the embodiments described in the filtering unit 160, inter-prediction unit 181 and intra-prediction unit 182 of the encoder 100 may be identically applied to the filtering unit 240, inter-prediction unit 261 and intra-prediction unit 262 of the decoder, respectively.

Specifically, the intra-prediction unit 262 according to the present invention may perform filtering on a reference sample close to the position of a predicted pixel within a current block when the distance between the predicted pixel and a reference pixel is greater than a given distance. The intra-prediction unit 262 is described more specifically later.

In general, the block-based image compression method is used in a technique (e.g., HEVC) for compressing a still image or a moving image. A block-based image compression method is a method of processing a video by splitting the video into specific block units, and may decrease the capacity of memory and a computational load.

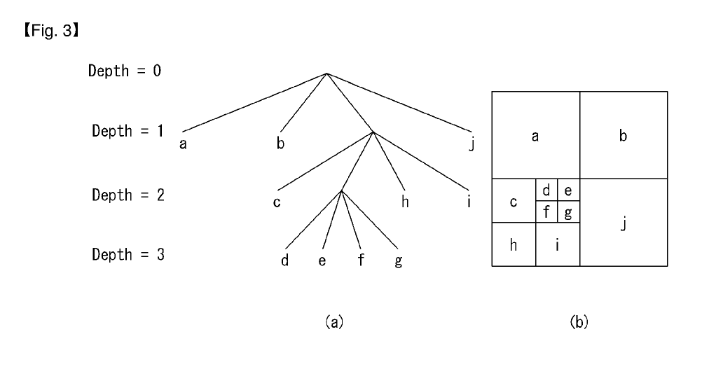

FIG. 3 is a diagram for illustrating the split structure of a coding unit that may be applied to the present invention.

The encoder splits a single image (or picture) in a coding tree unit (CTU) of a rectangle form, and sequentially encodes a CTU one by one according to raster scan order.

In HEVC, the size of a CTU may be determined to be one of 64×64, 32×32 and 16×16. The encoder may select and use the size of CTU according to the resolution of an input video or the characteristics of an input video. A CTU includes a coding tree block (CTB) for a luma component and a CTB for two chroma components corresponding to the luma component.

One CTU may be split in a quad-tree structure. That is, one CTU may be split into four units, each having a half horizontal size and half vertical size while having a square form, thereby being capable of generating a coding unit (CU). The split of the quad-tree structure may be recursively performed. That is, a CU is hierarchically from one CTU in a quad-tree structure.

A CU means a basic unit for a processing process of an input video, for example, coding in which intra/inter prediction is performed. A CU includes a coding block (CB) for a luma component and a CB for two chroma components corresponding to the luma component. In HEVC, the size of a CU may be determined to be one of 64×64, 32×32, 16×16 and 8×8.

Referring to FIG. 3, a root node of a quad-tree is related to a CTU. The quad-tree is split until a leaf node is reached, and the leaf node corresponds to a CU.

This is described in more detail. A CTU corresponds to a root node and has the deepest depth (i.e., depth=0) value. A CTU may not be split depending on the characteristics of an input video. In this case, the CTU corresponds to a CU.

A CTU may be split in a quad-tree form. As a result, lower nodes of a depth 1 (depth=1) are generated. Furthermore, a node (i.e., a leaf node) no longer split from the lower node having the depth of 1 corresponds to a CU. For example, in FIG. 3(b), a CU(a), CU(b) and CU(j) corresponding to nodes a, b and j have been once split from a CTU, and have a depth of 1.

At least one of the nodes having the depth of 1 may be split in a quad-tree form again. As a result, lower nodes of a depth 2 (i.e., depth=2) are generated. Furthermore, a node (i.e., leaf node) no longer split from the lower node having the depth of 2 corresponds to a CU. For example, in FIG. 3(b), a CU(c), CU(h) and CU(i) corresponding to nodes c, h and i have been twice split from the CTU, and have a depth of 2.

Furthermore, at least one of the nodes having the depth of 2 may be split in a quad-tree form again. As a result, lower nodes having a depth of 3 (i.e., depth=3) are generated. Furthermore, a node (i.e., leaf node) no longer split from the lower node having the depth of 3 corresponds to a CU. For example, in FIG. 3(b), a CU(d), CU(e), CU(f) and CU(g) corresponding to nodes d, e, f and g have been split from the CTU three times, and have a depth of 3.

In the encoder, a maximum size or minimum size of a CU may be determined according to the characteristics of a video image (e.g., resolution) or by considering encoding rate. Furthermore, information about the size or information capable of deriving the size may be included in a bit stream. A CU having a maximum size is referred to as the largest coding unit (LCU), and a CU having a minimum size is referred to as the smallest coding unit (SCU).

In addition, a CU having a tree structure may be hierarchically split with predetermined maximum depth information (or maximum level information). Furthermore, each split CU may have depth information. Since the depth information represents the split count and/or degree of a CU, the depth information may include information about the size of a CU.

Since the LCU is split in a quad-tree form, the size of the SCU may be obtained using the size of the LCU and maximum depth information. Alternatively, the size of the LCU may be obtained using the size of the SCU and maximum depth information of a tree.

For a single CU, information (e.g., a split CU flag (split_cu_flag)) indicating whether the corresponding CU is split may be forwarded to the decoder. The split information is included in all of CUs except the SCU. For example, when the value of the flag indicating whether to split is ‘1’, the corresponding CU is further split into four CUs, and when the value of the flag that represents whether to split is ‘0’, the corresponding CU is not split any more, and the processing process for the corresponding CU may be performed.

As described above, the CU is a basic unit of the coding in which the intra-prediction or the inter-prediction is performed. The HEVC splits the CU in a prediction unit (PU) for coding an input video more effectively.

The PU is a basic unit for generating a prediction block, and even in a single CU, the prediction block may be generated in different way by a unit of a PU. However, the intra-prediction and the inter-prediction are not used together for the PUs that belong to a single CU, and the PUs that belong to a single CU are coded by the same prediction method (i.e., intra-prediction or the inter-prediction).

The PU is not split in the Quad-tree structure, but is split once in a single CU in a predetermined form. This will be described by reference to the drawing below.

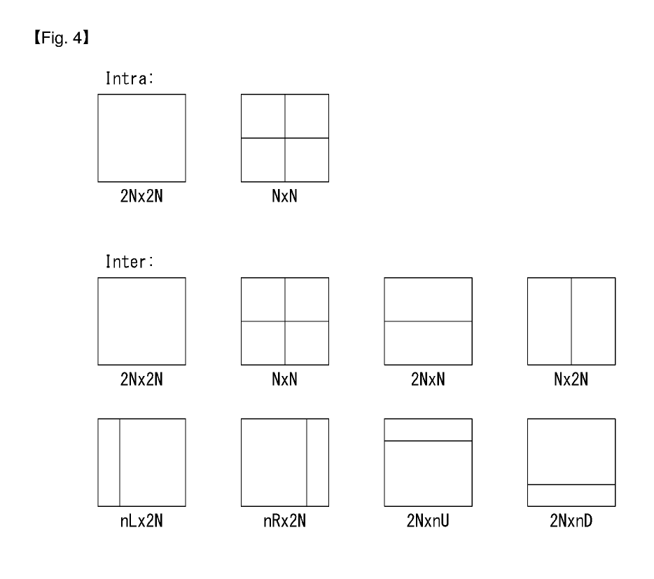

FIG. 4 is a diagram for illustrating a prediction unit that may be applied to the present invention.

A PU is differently split depending on whether the intra-prediction mode is used or the inter-prediction mode is used as the coding mode of the CU to which the PU belongs.

FIG. 4(a) illustrates a PU of the case where the intra-prediction mode is used, and FIG. 4(b) illustrates a PU of the case where the inter-prediction mode is used.

Referring to FIG. 4(a), assuming the case where the size of a single CU is 2N×2N (N=4, 8, 16 and 32), a single CU may be split into two types (i.e., 2N×2N or N×N).

In this case, in the case where a single CU is split into the PU of 2N×2N form, it means that only one PU is existed in a single CU.

In contrast, in the case where a single CU is split into the PU of N×N form, a single CU is split into four PUs, and different prediction blocks are generated for each PU unit. However, such a PU split may be performed only in the case where the size of a CB for the luma component of a CU is a minimum size (i.e., if a CU is the SCU).

Referring to FIG. 4(b), assuming that the size of a single CU is 2N×2N (N=4, 8, 16 and 32), a single CU may be split into eight PU types (i.e., 2N×2N, N×N, 2N×N, N×2N, nL×2N, nR×2N, 2N×nU and 2N×nD)

As in intra-prediction, the PU split of N×N form may be performed only in the case where the size of a CB for the luma component of a CU is a minimum size (i.e., if a CU is the SCU).

Inter-prediction supports the PU split of a 2N×N form in the horizontal direction and an N×2N form in the vertical direction.

In addition, the inter-prediction supports the PU split in the form of nL×2N, nR×2N, 2N×nU and 2N×nD, which is asymmetric motion split (AMP). In this case, ‘n’ means ¼ value of 2N. However, the AMP may not be used in the case where a CU to which a PU belongs is a CU of minimum size.

In order to efficiently encode an input video in a single CTU, the optimal split structure of a coding unit (CU), prediction unit (PU) and transform unit (TU) may be determined based on a minimum rate-distortion value through the processing process as follows. For example, as for the optimal CU split process in a 64×64 CTU, the rate-distortion cost may be calculated through the split process from a CU of a 64×64 size to a CU of an 8×8 size. A detailed process is as follows.

1) The optimal split structure of a PU and TU that generates a minimum rate distortion value is determined by performing inter/intra-prediction, transformation/quantization, dequantization/inverse transform and entropy encoding on a CU of a 64×64 size.

2) The optimal split structure of a PU and TU is determined by splitting a 64×64 CU into four CUs of a 32×32 size and generating a minimum rate distortion value for each 32×32 CU.

3) The optimal split structure of a PU and TU is determined by further splitting a 32×32 CU into four CUs of a 16×16 size and generating a minimum rate distortion value for each 16×16 CU.

4) The optimal split structure of a PU and TU is determined by further splitting a 16×16 CU into four CUs of an 8×8 size and generating a minimum rate distortion value for each 8×8 CU.

5) The optimal split structure of a CU in a 16×16 block is determined by comparing the rate-distortion value of the 16×16 CU obtained in the process of 3) with the addition of the rate-distortion value of the four 8×8 CUs obtained in the process of 4). This process is also performed on the remaining three 16×16 CUs in the same manner.

6) The optimal split structure of a CU in a 32×32 block is determined by comparing the rate-distortion value of the 32×32 CU obtained in the process of 2) with the addition of the rate-distortion value of the four 16×16 CUs obtained in the process of 5). This process is also performed on the remaining three 32×32 CUs in the same manner.

7) Lastly, the optimal split structure of a CU in a 64×64 block is determined by comparing the rate-distortion value of the 64×64 CU obtained in the process of 1) with the addition of the rate-distortion value of the four 32×32 CUs obtained in the process of 6).

In an intra-prediction mode, a prediction mode is selected in a PU unit, and prediction and reconstruction are performed on the selected prediction mode in an actual TU unit.

A TU means a basic unit by which actual prediction and reconstruction are performed. A TU includes a transform block (TB) for a luma component and two chroma components corresponding to the luma component.

In the example of FIG. 3, as if one CTU is split in a quad-tree structure to generate a CU, a TU is hierarchically split from one CU to be coded in a quad-tree structure.

A TU is split in the quad-tree structure, and a TU split from a CU may be split into smaller lower TUs. In HEVC, the size of a TU may be determined to be any one of 32×32, 16×16, 8×8 and 4×4.

Referring back to FIG. 3, it is assumed that the root node of the quad-tree is related to a CU. The quad-tree is split until a leaf node is reached, and the leaf node corresponds to a TU.

This is described in more detail. A CU corresponds to a root node and has the deepest depth (i.e., depth=0) value. A CU may not be split depending on the characteristics of an input video. In this case, the CU corresponds to a TU,

A CU may be split in a quad-tree form. As a result, lower nodes, that is, a depth 1 (depth=1), are generated. Furthermore, a node (i.e., leaf node) no longer split from the lower node having the depth of 1 corresponds to a TU. For example, in FIG. 3(b), a TU(a), TU(b) and TU(j) corresponding to the nodes a, b and j have been once split from a CU, and have a depth of 1.

At least one of the nodes having the depth of 1 may be split again in a quad-tree form. As a result, lower nodes, that is, a depth 2 (i.e., depth=2), are generated. Furthermore, a node (i.e., leaf node) no longer split from the lower node having the depth of 2 corresponds to a TU. For example, in FIG. 3(b), a TU(c), TU(h) and TU(i) corresponding to the nodes c, h and i have been split twice from the CU, and have a depth of 2.

Furthermore, at least one of the nodes having the depth of 2 may be split in a quad-tree form again. As a result, lower nodes having a depth of 3 (i.e., depth=3) are generated. Furthermore, a node (i.e., leaf node) no longer split from a lower node having the depth of 3 corresponds to a CU. For example, in FIG. 3(b), a TU(d), TU(e), TU(f), TU(g) corresponding to the nodes d, e, f and g have been split from the CU three times, and have the depth of 3.

A TU having a tree structure may be hierarchically split based on predetermined highest depth information (or highest level information). Furthermore, each split TU may have depth information. The depth information may also include information about the size of the TU because it indicates the number of times and/or degree that the TU has been split.

With respect to one TU, information (e.g., a split TU flag (split_transform_flag)) indicating whether a corresponding TU has been split may be transferred to the decoder. The split information is included in all TUs other than a TU of the least size. For example, if the value of the flag indicating whether a TU has been split is ‘1’, the corresponding TU is split into four TUs. If the value of the flag ‘0’, the corresponding TU is no longer split.

### Prediction

In order to reconstruct a current processing unit on which decoding is performed, the decoded part of a current picture including the current processing unit or other pictures may be used.

A picture (slice) using only a current picture for reconstruction, that is, performing only intra-prediction, may be referred to as an intra-picture or I picture (slice). A picture (slice) using the greatest one motion vector and reference index in order to predict each unit may be referred to as a predictive picture or P picture (slice). A picture (slice) using a maximum of two motion vectors and reference indices in order to predict each unit may be referred to as a bi-predictive picture or B picture (slice).

Intra-prediction means a prediction method of deriving a current processing block from a data element (e.g., sample value, etc.) of the same decoded picture (or slice). That is, intra-prediction means a method of predicting a pixel value of the current processing block with reference to reconstructed regions within a current picture.

Inter-prediction means a prediction method of deriving a current processing block based on a data element (e.g., sample value or motion vector) of a picture other than a current picture. That is, inter-prediction means a method of predicting the pixel value of the current processing block with reference to reconstructed regions within another reconstructed picture other than a current picture.

Hereinafter, intra-prediction is described in more detail.

### Intra Prediction (or Intra-Frame Prediction)

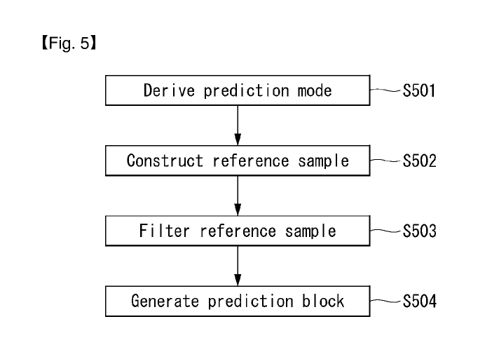

FIG. 5 is an embodiment to which the present invention is applied and is a diagram illustrating an intra-prediction method.

Referring to FIG. 5, the decoder derives the intra-prediction mode of a current processing block (S501).

In intra-prediction, each prediction mode may have a prediction direction for the position of a reference sample used for prediction. An intra-prediction mode having a prediction direction is referred to as an intra-angular prediction mode (Intra_Angular prediction mode). In contrast, an intra-prediction mode not having a prediction direction includes an intra-planar (INTRA_PLANAR) prediction mode, an intra-DC (INTRA_DC) prediction mode.

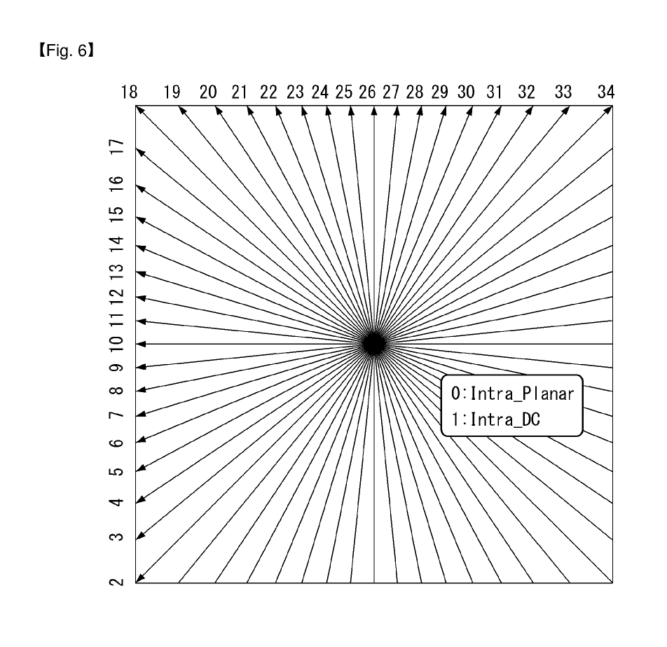

Table 1 illustrates intra-prediction modes and associated names, and FIG. 6 illustrates prediction directions according to intra-prediction modes.

TABLE 1

| Intra | |
|---|---|
| prediction | |
| mode | Associated name |
| 0 | intra-planar (INTRA_PLANAR) |
| 1 | intra-DC (INTRA_DC) |
| 2 . . . 34 | intra-angular 2 . . . intra-angular 34 |
| | (INTRA_ANGULAR2 . . . INTRA_ANGULAR34) |

In intra-prediction, prediction is performed on a current processing block based on a derived prediction mode. A detailed prediction method for a reference sample used for prediction is different based on a prediction mode. If a current block has been encoded in an intra-prediction mode, the decoder derives the prediction mode of the current block in order to perform prediction.

The decoder identifies whether neighboring samples of the current processing block may be used for prediction and constructs reference samples to be used for prediction (S502).

In intra-prediction, neighboring samples of a current processing block mean a sample neighboring the left boundary of the current processing block of an nS×nS size and a total of 2×nS samples neighboring the bottom left of the current processing block, a sample neighboring the top boundary of the current processing block and a total of 2×nS samples neighboring the top right of the current processing block and one sample neighboring the top left of the current processing block.

However, some of neighboring samples of the current processing block has not yet been decoded or may not be available. In this case, the decoder may construct reference samples to be used for prediction by substituting unavailable samples with available samples.

The decoder may perform filtering on the reference samples based on the intra-prediction mode (S503).

Whether or not to perform filtering on the reference samples may be determined based on the size of the current processing block. Furthermore, a filtering method of the reference samples may be determined by a filtering flag transmitted by the encoder.

The decoder generates a prediction block for the current processing block based on the intra-prediction mode and the reference samples (S504). That is, the decoder generates the prediction block for the current processing block (i.e., generate a prediction sample within the current processing block) based on the intra-prediction mode derived in the intra-prediction mode derivation step (S501) and the reference samples obtained through the reference sample configuration step (S502) and the reference sample filtering step (S503).

If the current processing block has been encoded in the INTRA_DC mode, in order to minimize the discontinuity of the boundary between processing blocks, a left boundary sample of a prediction block (i.e., a sample within the prediction block neighboring the left boundary) and a top boundary sample (i.e., a sample within the prediction block neighboring the top boundary) may be filtered in step S504.

Furthermore, in step S504, filtering may be applied to the left boundary sample or the top boundary sample similar to the INTRA_DC mode with respect to a vertical mode and a horizontal mode among intra-angular prediction modes.

More specifically, if the current processing block has been encoded in the vertical mode or the horizontal mode, a value of a prediction sample may be derived based on a reference sample positioned in a prediction direction. In this case, a boundary sample not positioned in the prediction direction among the left boundary sample or top boundary sample of a prediction block may neighbor a reference sample not used for prediction. That is, a distance from the reference sample not used for prediction may be much closer than a distance from a reference sample used for the prediction.

Accordingly, the decoder may adaptively apply filtering to left boundary samples or top boundary samples depending on whether an intra-prediction direction is a vertical direction or a horizontal direction. That is, when the intra-prediction direction is a vertical direction, the decoder may apply filtering to the left boundary samples. When the intra-prediction direction is a horizontal direction, the decoder may apply filtering to the top boundary samples.

A pixel to be referred for prediction may be smoothing (or filtering)-processed based on the size of a current block and a pixel value. This is for reducing the visual artifacts of a prediction block which may be derived due to a difference between the pixel values of reference pixels (or reference samples).

A method used when a block within a frame is predicted using a pixel neighboring a current block may be basically divided into two methods. The method may be divided into an angular prediction method of constructing a prediction block by duplicating a reference pixel positioned in a specific direction and a non-angular prediction method (DC mode, Planar mode) of using a pixel to which reference can be made.

The angular prediction method was designed to represent structures having various directions which may appear in an image (or picture). As described in FIG. 6, the angular prediction method may be performed by designating a specific direction as a prediction mode and duplicating a reference pixel corresponding to a prediction mode angle based o the position of a sample to be predicted.

If a reference pixel cannot be used in an integer pixel unit, a prediction block may be constructed by duplicating an interpolated pixel using a distance ratio between two reference pixels and two pixels derived from the angle of the prediction direction.

In order to calculate the position of a sub-pixel (i.e., interpolated pixel), in HEVC, a tan value and tan \hat{ }(−1) value for the angle θ of each intra-prediction mode have been previously scaled in an integer unit and defined so that they can be easily computed. Scaled tan values defined for each intra-prediction mode are shown in Table 2.

TABLE 2

| | | | | | | | | | | | | | | | | | |
|---|---|---|---|---|---|---|---|---|---|---|---|---|---|---|---|---|---|
| predModeIntra | 1 | 2 | 3 | 4 | 5 | 6 | 7 | 8 | 9 | 10 | 11 | 12 | 13 | 14 | 15 | 16 | 17 |
| intraPredAngle | — | 32 | 26 | 21 | 17 | 13 | 9 | 5 | 2 | 0 | −2 | −5 | −9 | −13 | −17 | −21 | −26 |
| predModeIntra | 18 | 19 | 20 | 21 | 22 | 23 | 24 | 25 | 26 | 27 | 28 | 29 | 30 | 31 | 32 | 33 | 34 |
| intraPredAngle | −32 | −26 | −21 | −17 | −13 | −9 | −5 | −2 | 0 | 2 | 5 | 9 | 13 | 17 | 21 | 26 | 32 |

Furthermore, scaled tan \hat{ }(−1) values defined for each intra-prediction mode are shown in Table 3.

TABLE 3

| | | | | | | | |
|---|---|---|---|---|---|---|---|
| predModeIntra | 11 | 12 | 13 | 14 | 15 | 16 | 17 |
| invAngle | −4096 | −1638 | −910 | −630 | −482 | −390 | −315 |
| predModeIntra | 19 | 20 | 21 | 22 | 23 | 24 | 25 |
| invAngle | −315 | −390 | −482 | −630 | −910 | −1638 | −4096 |

A DC mode, that is, one of non-angular prediction modes, is a method of constructing a prediction block based on an average value of reference pixels (or reference samples) neighboring a current block. If pixels within a block are homogeneous, effective prediction can be expected. In contrast, if reference pixels neighboring a current block have various values, discontinuity may occur between a prediction block and a reference sample. When prediction is performed according to the angular prediction method in a similar situation, unwanted visible contouring may occur. The Planar mode was designed to supplement the unwanted visible contouring. In the Planar prediction method, a prediction block is constructed by performing horizontal linear prediction and vertical linear prediction using a reference pixel and then averaging them.

As described above, after the prediction block is constructed, post-processing filtering for reducing the discontinuity of the reference sample and the block boundary may be performed on a block predicted according to the horizontal direction mode, the vertical direction mode and DC mode. Thereafter, an encoded block within a frame may be reconstructed by adding the prediction block and a residual signal that has been input and inverse-transformed as a pixel area.

A decoding process in the case of the intra-frame prediction mode is described. If a currently decoded block has been encoded in an intra-frame prediction mode (or intra-prediction mode), the decoder decodes an encoded residual signal received from the encoder. Furthermore, the decoder decodes a signal symbolized based on the probability in the entropy decoder, and reconstructs the residual signal of a pixel area through dequantization and inverse transform. Furthermore, the decoder generates a prediction block using an intra-frame prediction mode, received from the encoder through the intra-frame prediction unit, and a neighboring reference sample of an already reconstructed current block. Furthermore, the decoder reconstructs a block encoded as intra-frame prediction by adding the prediction signal and the decoded residual signal.

### Intra-Prediction-Based Video Processing Method

As described above, in HEVC, the prediction block of a current block is generated using 33 types of angular prediction methods and 2 types of non-angular prediction methods: a total of 35 prediction methods for intra-frame prediction.

In the case of the 33 types of angular prediction mode, when a prediction sample is calculated from reference samples, a reference sample value is duplicated to a corresponding prediction sample by taking each angle into consideration.

In this case, each sample (or pixel) within a prediction block may have a different distance from a reference sample (or reference pixel) depending on the position of the sample.

As described above, if samples neighboring the left, top, left top of a current block are used as reference samples in intra-prediction, in the case of a sample positioned on the right or bottom of the current block, a distance from a reference sample (or reference pixel) may be relatively distant due to a prediction mode (or prediction direction).

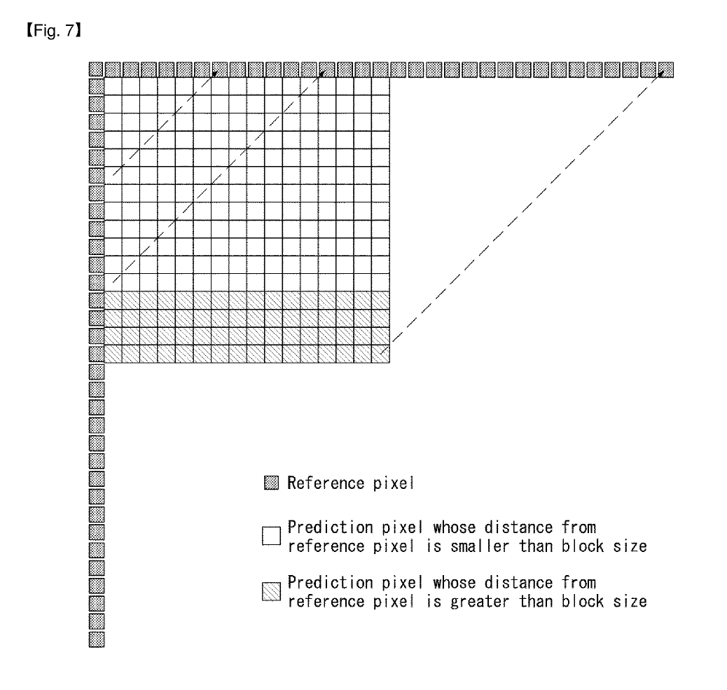

FIG. 7 is a diagram for illustrating the distance between a prediction sample and a reference sample according to an intra-prediction direction.

Referring to FIG. 7, a case where the angle of an intra-prediction mode is 45° is assumed and described, for convenience of description. Slashed pixels (or samples) have a longer distance from a reference pixel (or reference sample) than not-slashed pixels. Specifically, the slashed pixels (or samples) correspond to a case where the distance from the reference pixel (or reference sample) is greater than the length of one side of a current prediction block.

As described above, in intra-prediction, a sample value of a reference sample is duplicated based on the direction of an intra-prediction mode. Accordingly, when the distance between a prediction sample and the reference sample is distant, the accuracy of prediction may be reduced compared to a sample whose distance from the reference sample is not distant.

That is, when compared to samples not slashed in FIG. 7, the slashed samples may have a much higher error rate because they have a relatively longer distance from the reference sample. As the distance between the prediction sample and the reference sample increases, the error rate may rise. As a result. compression performance may be degraded because a residual signal increases.

In order to solve the problem, the present invention proposes a method capable of improving the accuracy of prediction by filtering a reference sample close to the position of a prediction sample within a current block when the distance between the prediction sample and the reference sample is greater than a given distance.

Hereinafter, in the description of the present invention, a prediction sample (or predicted pixel) is a sample (or pixel) present within a prediction block, and may mean a sample (or pixel) having a value duplicated from a reference sample (or a sample interpolated based on the angle of a prediction mode) value based on the direction of an intra-prediction mode.

Furthermore, in the description of the present invention, vertical coordinates (or vertical direction coordinates) are denoted as x and horizontal coordinates (or horizontal coordinates) are denoted as y, for convenience of description, but are not limited thereto. That is, the horizontal coordinates may be referred to as x, and the vertical coordinates may be referred to as y.

Furthermore, in the description of the present invention, a first reference sample may mean a reference sample (or interpolated sample) used to generate a prediction sample value based on the direction of an intra-prediction mode. A second reference sample may mean a reference sample used to perform filtering according to an embodiment of the present invention.

### Embodiment 1

The present embodiment proposes a method of determining whether or not to perform filtering based on the distance between a prediction sample (or predicted pixel) and a reference sample (or reference pixel) and performing a weighted sum with a reference sample close to the position of the prediction sample when the filtering is determined.

In the description of the present embodiment, a criterion for determining whether or not to perform filtering is determined to be the length of one side of a prediction block and an offset of a given size, for convenience of description, but is not essentially limited thereto. In other words, the criterion for determining whether or not to perform filtering may be determined to be the length of one side of a current block to which an offset of a given size has not been added or may be determined to be a specific value regardless of the length of one side of a current block.

Equation 1 illustrates a filtering method when a criterion for determining whether or not to perform filtering is an added value of the length of one side of a prediction block (or current block) (i.e., the width or height of a prediction block) and an offset of a given size.

$$Filter ( P ( x , y ) ) = \{ \begin{matrix}P ( x , y ) , \\ Dist ( x , y , mode ) < b + offset \\ α \cdot P ( x , y ) + β ( ref ( x , - 1 ) + ref ( - 1 , y ) ) , \\ Dist ( x , y , mode ) \geq b + offset\end{matrix} \qquad [ Equation 1 ]$$

In this case, P(x,y) may mean a prediction sample value positioned in (x,y) within a prediction block. In this case, x may mean vertical coordinates (or vertical direction coordinates), and y may mean horizontal coordinates (or horizontal direction coordinates) (e.g., the coordinates of a left-top sample within the prediction block may correspond to (0,0)). b may mean the length of one side of the prediction block. Dist(x,y,mode) may mean the distance between the prediction sample and a first reference sample according to an intra-prediction mode.

Furthermore, α, β may be defined as weights applied to the prediction sample and a second reference sample. In this case, the weights α and β are α+β=1, and may satisfy α≥β. In this case, the weights α and β may be scaled and used as integers depending on implementation convenience.

Hereinafter, in the description of the present embodiment (i.e., embodiment 1), a value of an offset of a given size added to the length of one side of a prediction block is referred to as a “filtering criterion value”, for convenience of description.

Referring to Equation 1, first, when the distance between the prediction sample and the first reference sample is smaller than the filtering criterion value, filtering may not be applied.

In contrast, when the distance between the prediction sample and the first reference sample is greater than or equal to the filtering criterion value, filtering may be applied.

If the filtering is applied, a filtered value may be calculated by applying the weight a to the prediction sample value P(x,y), applying the weight β to an added value of a second reference sample ref(x,−1) (or a reference sample having the same vertical coordinates as the prediction sample) closest to a prediction sample among reference samples neighboring the left of the prediction block (or current block) and a second reference sample ref(−1,y) (or a reference sample having the same horizontal coordinates as the prediction sample) closest to a prediction sample among reference samples neighboring the top of the prediction block, and adding values to which the weight α and the weight β have been respectively applied.

In this case, in order to apply the filtering, as illustrated in Equation 1, both the second reference sample ref(x,−1) on the left and the second reference sample ref(−1,y) at the top may be used. Unlike in the example of Equation 1, in order to apply the filtering, only the second reference sample ref(x,−1) on the left may be used or the second reference sample ref(−1,y) at the top may be used.

Furthermore, the encoder/decoder may use only the left reference sample ref(x,−1) or the top reference sample ref(−1,y) or may use both the left reference sample ref(x,−1) and the top reference sample ref(−1,y), as the second reference sample, based on an intra-prediction mode.

The filtering method in the present embodiment may be defined only with respect to an angular prediction mode of the intra-prediction modes. Furthermore, when a criterion for applying filtering is greater than the length of one side of a prediction block, the filtering method in the present embodiment may not be applied in a horizontal mode and a vertical mode because all prediction samples within the prediction block are shorter than the length of one side of the prediction block in the horizontal mode (e.g., in the case of FIG. 6, the No. 10 prediction mode) and the vertical mode (e.g., in the case of FIG. 6, the No. 26 prediction mode).

The distance between the prediction sample and the first reference sample may be calculated using a tan value and a tan \hat{ }(−1) value for the angle θ of a prediction mode because the tan value and the tan \hat{ }(−1) value may be previously determined as in Table 2 and Table 3 in order to identify the position of the first reference sample according to the angular prediction mode, for example.

Hereinafter, in the description of the present invention, an example in which an intra-prediction mode is the prediction mode (refer to FIG. 6) of HEVC is described, for convenience of description. That is, the angular prediction mode is divided and denoted the No. 2 mode to No. 34 mode of HEVC, but the present invention is not limited thereto.

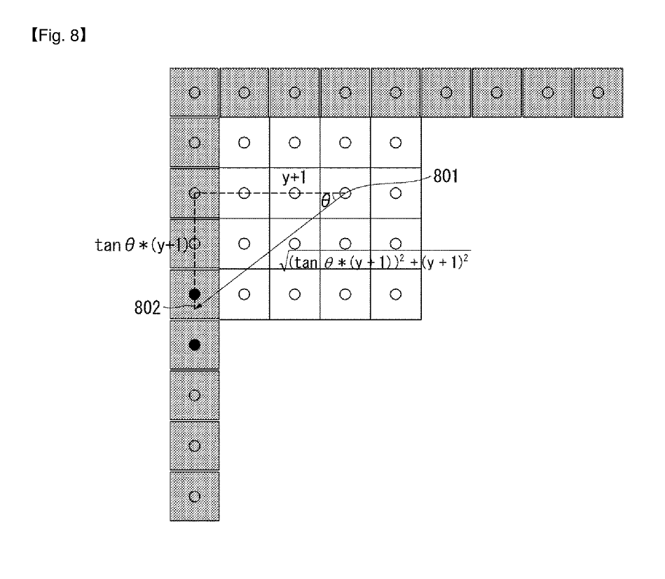

FIG. 8 is a diagram for illustrating a method of calculating a distance from a reference sample according to an embodiment of the present invention.

FIG. 8 illustrates a case where the angle of an intra-prediction mode is an angle using only a left reference sample as a first reference sample (i.e., when a prediction mode belongs to the No. 2 to No. 9 modes). In this case, the distance between a prediction sample 801 and a first reference sample 802 may be represented like Equation 2.

{square root over ((tan θ*(y+1))²+(y+1)²)} [Equation 2]

That is, when the intra-prediction mode is one of the No. 2 to No. 9 modes and the coordinates of the prediction sample 801 are (x,y), the distance between the prediction sample 801 and the first reference sample 802 may be calculated like Equation 2 using a (y+1) value and a tan θ value. In this case, as described above, the values defined in Table 2 may be used to calculate the distance between the prediction sample 801 and the first reference sample 802.

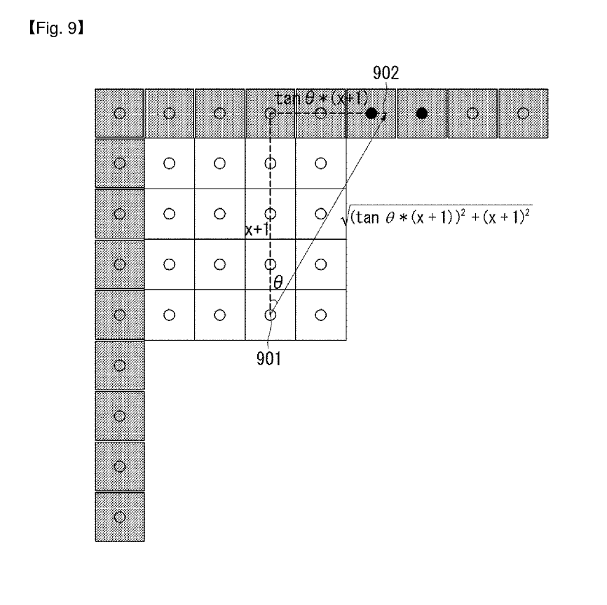

FIG. 9 is a diagram for illustrating a method of calculating a distance from a reference sample according to an embodiment of the present invention.

FIG. 9 illustrates a case where the angle of an intra-prediction mode is an angle using only a top reference sample as a first reference sample (i.e., when a prediction mode belongs to the Nos. 27 to 34 modes). In this case, the distance between a prediction sample 901 and a first reference sample 902 may be represented like Equation 3.

{square root over ((tan θ*(x+1))²+(x+1)²)} [Equation 3]

That is, when the intra-prediction mode is one of the Nos. 27 to 34 modes and the coordinates of the prediction sample 901 are (x,y), the distance between the prediction sample 901 and the first reference sample 902 may be calculated like Equation 3 using an (x+1) value and a tan θ value. In this case, as described above, the values defined in Table 2 may be used to calculate the distance between the prediction sample 901 and the first reference sample 902.

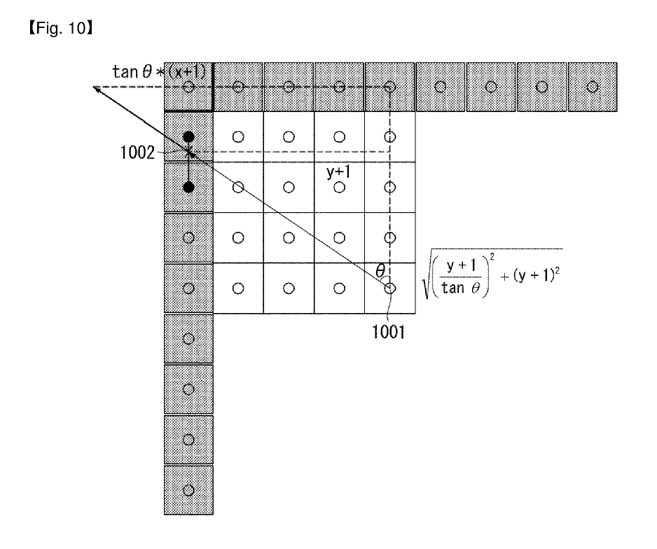

FIG. 10 is a diagram for illustrating a method of calculating a distance from a reference sample according to an embodiment of the present invention.

FIG. 10 illustrates a case where an intra-prediction mode is a mode using an inverse angle (i.e., when a prediction mode belongs to the No. 11 to No. 25 modes and the direction of the intra-prediction mode is a negative angle direction). In this case, the distance between a prediction sample 1001 and a first reference sample 1002 may be represented like Equation 4.

$$\sqrt{{( \frac{y + 1}{tan θ} )}^{2} + {( y + 1 )}^{2}} \qquad [ Equation 4 ]$$

That is, when the intra-prediction mode is one of the No. 11 to No. 25 modes and the coordinates of the prediction sample 1001 are (x,y), the distance between the prediction sample 1101 and the first reference sample 1002 may be calculated like Equation 4 using a (y+1) value and a tan θ value. In this case, as described above, the values defined in Table 2 or Table 3 may be used to calculate the distance between the prediction sample 1001 and the first reference sample 1002.

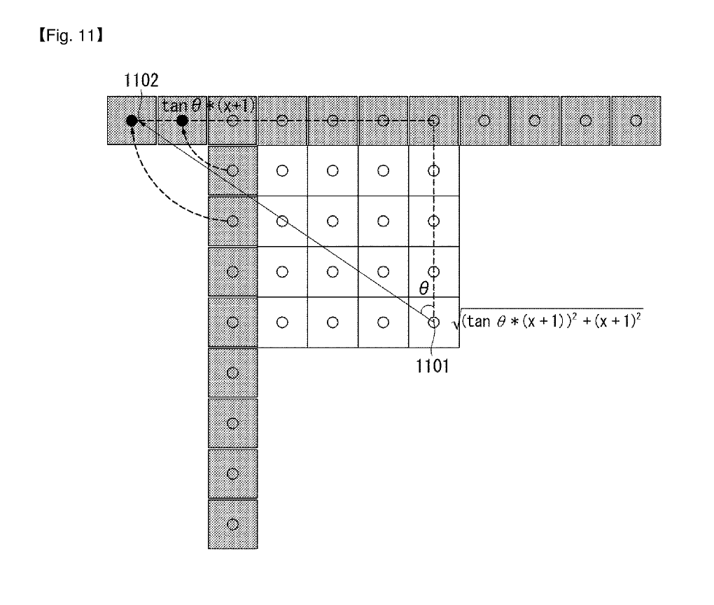

FIG. 11 is a diagram for illustrating a method of calculating a distance from a reference sample according to an embodiment of the present invention.

FIG. 11 illustrates a case where an intra-prediction mode is a mode using an Inverse angle (i.e., when a prediction mode belongs to the No. 11 to No. 25 modes and the direction of the intra-prediction mode is a negative angle direction).

Hereinafter, in the description of the present invention, a case where the direction of an intra-prediction mode is a negative angle direction may mean a mode in which the intra-prediction mode uses an inverse angle, that is, a prediction mode in which the intraPredAngle value in Table 2 is a negative number.

In this case, whether or not to perform filtering may be determined using the distance between a prediction sample 1101 and a first reference sample 1102 positioned in a main reference sample array.

A left or reference sample array may mean a main reference sample array based on an intra-prediction mode. Specifically, a top reference sample array may become a main reference sample array in the case of the vertical mode of modes using an inverse angle (i.e., when a prediction mode belongs to the No. 18 to No, 25 modes). A left reference sample array may become a main reference sample array in the case of the horizontal of the modes using an inverse angle (i.e., when a prediction mode belongs to the No. 11 to No, 17 modes).

In the vertical mode of the modes using an inverse angle, a prediction sample may be generated with reference to the top reference sample array (i.e., the main reference sample array). However, the left reference sample may be used to generate the prediction sample in addition to the top reference sample because the inverse angle is used. In this case, the top reference sample array (i.e., the main reference sample array) may be extended because the left reference sample used to generate the prediction sample is added to the top reference sample array.

Likewise, in the horizontal mode of the modes using an inverse angle, the left reference sample array (i.e., the main reference sample array) may be extended because the top reference sample used to generate a prediction sample is added to the left reference sample array.

The distance between the prediction sample 1101 and the first reference sample 1102 positioned in the main reference sample array may be represented like Equation 5.

{square root over ((tan θ*(x+1))²+(x+1)²)} [Equation 5]

That is, when an intra-prediction mode is one of the No. 11 to No. 25 modes and the coordinates of the prediction sample 1101 are (x,y), the distance between the prediction sample 1101 and the first reference sample 1102 may be calculated like Equation 5 using an (x+1) value and a tan θ value. In this case, as described above, the values defined in Table 2 or Table 3 may be used to calculate the distance between the prediction sample 1101 and the first reference sample 1102.

In FIGS. 8 to 11, the methods of calculating the distance between a prediction sample and a first reference sample have been described.

In contrast, the encoder/decoder may table and refer to distance information on the position of a prediction sample for each block size and each prediction mode in order to simplify a procedure for calculating the distance between the prediction sample and a first reference sample.

Furthermore, as in the illustrated filtering method of Equation 1, the encoder/decoder represents the weighted sum of a current prediction sample and a second reference sample, but may define a second reference sample used for filtering to have a weight according to a distance from the prediction sample. For example, this may be represented like Equation 6.

$$Filter ( P ( x , y ) ) = \{ \begin{matrix}P ( x , y ) , \\ Dist ( x , y , mode ) < b + offset \\ α \cdot P ( x , y ) + β ( \frac{x}{b} \cdot ref ( x , - 1 ) + \frac{y}{b} \cdot ref ( - 1 , y ) ) , \\ Dist ( x , y , mode ) \geq b + offset\end{matrix} \qquad [ Equation 6 ]$$

A difference from Equation 1 is chiefly described, before the weight β is applied to a reference sample of a vertical direction and a reference sample of a horizontal direction, a weight may be applied to a second reference sample ref(x,−1) closest to a prediction sample (i.e., a sample having the same vertical coordinates as the prediction sample) among reference samples neighboring the left of a prediction block (or current block) as much as a value of the vertical coordinates x divided by the length b of one side of the prediction block. Furthermore, a weight may be applied to a second reference sample ref(−1,y) closest to a prediction sample (i.e., a sample having the same horizontal coordinates as the prediction sample) among reference samples neighboring the top of a prediction block as much as a value of the horizontal coordinates y divided by the length b of one side of the prediction block.

The encoder/decoder may assign a higher weight to a second reference sample closer to a prediction sample when it performs filtering by applying, to the second reference sample, the weight according to a distance from the prediction sample as described above. Accordingly, the accuracy of prediction can be improved.

Furthermore, only the second reference sample closest to the prediction sample may be used when filtering is applied. For example, this may be represented like Equation 7.

$$Filter ( P ( x , y ) ) = \{ \begin{matrix}P ( x , y ) , \\ Dist ( x , y , mode ) < b + offset \\ α \cdot P ( x , y ) + β \cdot ( ref ( i , j ) ) , \\ Dist ( x , y , mode ) \geq b + offset\end{matrix} where \\ i = \{ \begin{matrix}- 1 , & x < y \\ x , & x \geq y\end{matrix} \\ and \\ j = \{ \begin{matrix}- 1 , & x \geq y \\ y , & x < y\end{matrix} \qquad [ Equation 7 ]$$

A difference from Equation 1 is chiefly described, the size of vertical coordinates x may be compared with the size of horizontal coordinates y. When x is greater than or equal to y, only a reference sample ref(x,−1) closest to a prediction sample among reference samples neighboring the left of a prediction block (or current block) may be used as a second reference sample. In contrast, when y is greater than x, only a reference sample ref(−1,y) closest to a prediction sample among reference samples neighboring the top of a prediction block may be used as a second reference sample.

That is, the encoder/decoder may perform filtering using only the second reference sample among reference samples neighboring the prediction block (or current block).

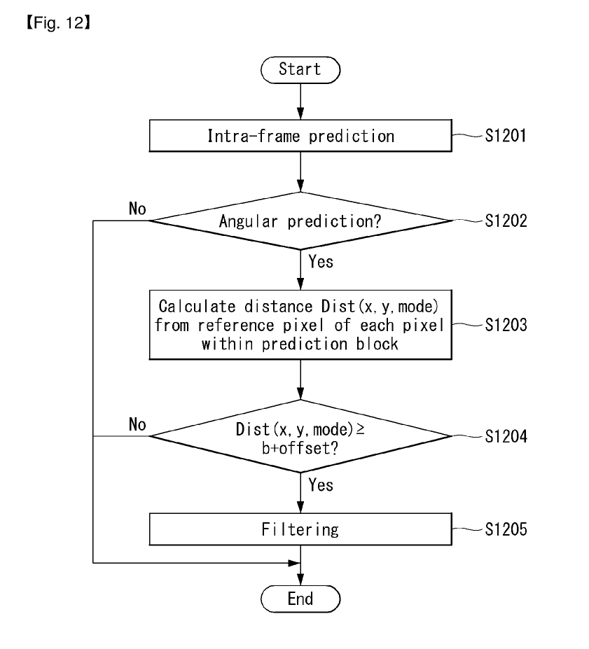

FIG. 12 is a diagram illustrating an intra prediction method according to an embodiment of the present invention.

The encoder/decoder performs intra-frame prediction on a current processing block (S1201).

That is, the filtering method proposed in the present embodiment may be applied when intra-frame prediction is performed. First, the encoder/decoder may generate a prediction block based on an intra-frame prediction mode. As described above, the encoder/decoder may derive an intra-frame prediction mode, and may duplicate a first reference sample value to a prediction sample within the prediction block based on the direction of the intra-frame prediction mode.

In this case, the encoder/decoder may apply the filtering method of the present embodiment in a block unit after it calculates a prediction sample value with respect to all samples within the current block (or prediction block), and may apply the present filtering method in a sample unit in a process of searching for each prediction sample within the current block (or prediction block).

The encoder/decoder determines whether a prediction mode of the current block is an angular prediction mode (S1202).

If, as a result of the determination in step S1202, the prediction mode of the current block is not an angular prediction mode (i.e., if the prediction mode is a non-angular prediction mode, such as a Planar mode or a DC mode), the filtering method of the present embodiment may not be applied as described above.

In contrast, if, as a result of the determination in step S1202, the prediction mode of the current block is an angular prediction mode, the encoder/decoder calculates the distance between each sample (i.e., prediction sample or predicted pixel) within a prediction block and a first reference sample (S1203).

In this case, the distance Dist(x,y,mode) between the prediction sample and the first reference sample may be calculated by the methods described in FIGS. 8 to 11. Furthermore, the distance may be calculated using a tan value and a tan \hat{ }(−1) value for the angle θ of the prediction mode because the tan value and the tan \hat{ }(−1) value may be previously determined as in Table 2 and Table 3 in order to identify the position of the first reference sample according to the angular prediction mode.

Furthermore, the encoder/decoder may table and refer to distance information on the position of the prediction sample for each block size and each prediction mode in order to simplify a procedure for calculating the distance between the prediction sample and the first reference sample.

The encoder/decoder determines whether the distance between the prediction sample and the first reference sample is greater than or equal to an added value (i.e., filtering criterion value) of the length of one side of the prediction block and an offset of a given size (S1204).

That is, the encoder/decoder may compare the value, calculated in S1203, with the filtering criterion value in order to determine whether or not to apply filtering to the prediction sample.

As described above, a criterion for determining whether or not to perform filtering (i.e., filtering criterion value) is determined to be the length of one side of a prediction block (i.e., the width or height of the prediction block) and an offset of a given size and described, but is not limited thereto.

If, as a result of the determination in step S1204, the distance between the prediction sample and the first reference sample is smaller than the filtering criterion value, filtering may not be applied.

In contrast, if, as a result of the determination in step S1204, the distance between the prediction sample and the first reference sample is greater than or equal to the filtering criterion value, filtering is applied to the prediction sample (S1205).

As described in Equation 1, the filtering may be performed by applying weights to the prediction sample value and a second reference sample value closest to the position of the prediction sample and combining them.

Furthermore, as described in Equation 6, the weighted sum of the current prediction sample and the second reference sample is represented, but each second reference sample used for filtering may be defined to have a weight according to a distance from the prediction sample. A higher weight may be assigned to the second reference sample closer to the prediction sample when the filtering is performed because the weight according to the distance from the prediction sample is applied to the second reference sample.

Furthermore, as described above, when the filtering is applied, only a second reference sample close to the prediction sample among the second reference samples may be used.

The filtering method proposed in the present embodiment may be applied to a luma component sample or a chroma component sample.

Furthermore, as described above, after the prediction block is constructed based on the intra-prediction mode, post-processing filtering for reducing the discontinuity of the reference sample and the block boundary may be performed on a block predicted in a horizontal direction mode, a vertical direction mode or a DC mode. The filtering method of the present embodiment may be performed prior to the post-processing filtering or may be performed after the post-processing filtering.

### Embodiment 2

In the embodiment 1, a filtering method in which a prediction block is assumed to be a square block has been described. However, a prediction block may have a form of a non-square block in addition to a square block.

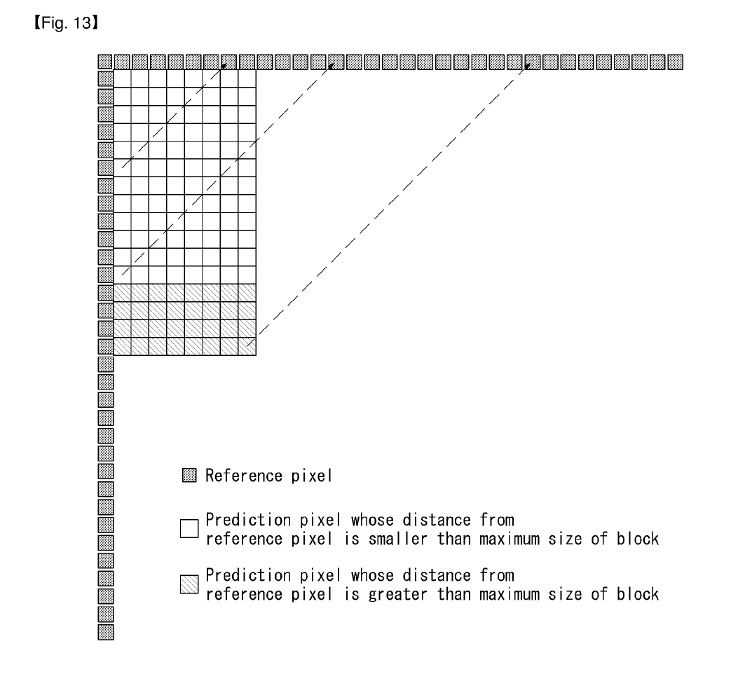

FIG. 13 is a diagram for illustrating the distance between a prediction sample and a reference sample according to an intra-prediction direction.

Referring to FIG. 13, a case where the angle of an intra-prediction mode is 45° is assumed and described, for convenience of description. Slashed samples (or pixels) have a longer distance from a reference sample (reference pixel) than not-slashed samples (or pixels). Specifically, the slashed samples (or pixels) correspond to a case where the distance from the reference sample (reference pixel) is greater than the length of a larger side among the lengths of sides of a current prediction block.

As described above, in intra-prediction, a sample value of a reference sample is duplicated based on the direction of an intra-prediction mode. Accordingly, when the distance between a prediction sample and the reference sample is distant, the accuracy of prediction may be reduced compared to a sample whose distance from the reference sample is not distant.

That is, when compared to samples not slashed in FIG. 13, the slashed samples may have a much higher error rate because they have a relatively longer distance from a reference sample. As the distance between the prediction sample and the reference sample increases, the error rate may rise. As a result, compression performance may be degraded because a residual signal increases.

In order to solve the problem, the present embodiment proposes a method capable of improving the accuracy of prediction by filtering a reference sample close to the position of a prediction sample within a current block when the distance between the prediction sample and the reference sample is greater than a given distance.

Specifically, in the present embodiment, a filtering method in which a prediction block is assumed to be a non-square block is described.

The present embodiment proposes a method of determining whether or not to perform filtering based on the distance between a prediction sample and a reference sample and performing a weighted sum with a reference sample close to the position of the prediction sample when the filtering is determined.

In the description of the present embodiment, a criterion for determining whether or not to perform filtering is determined to be the length of one side of a prediction block and an offset of a given size and described, for convenience of description, but is not essentially limited thereto. In other words, the criterion for determining whether or not to perform filtering may be determined to be the length of one side of a current block to which an offset of a given size has not been added or may be determined to be a specific value regardless of the length of one side of a current block.

Equation 8 illustrates a filtering method when a criterion for determining whether or not to perform filtering is an added value of the length of a larger side in a prediction block (or current block) and an offset of a given size.

$$Filter ( P ( x , y ) ) = \{ \begin{matrix}P ( x , y ) , \\ Dist ( x , y , mode ) < max ( BLOCK\_SIZE ) + offset \\ α \cdot P ( x , y ) + β ( ref ( x , - 1 ) + ref ( - 1 , y ) ) , \\ Dist ( x , y , mode ) \geq max ( BLOCK\_SIZE ) + offset\end{matrix} \qquad [ Equation 8 ]$$

In this case, P(x,y) may mean a prediction sample value positioned in (x,y) within a prediction block. In this case, x may mean vertical coordinates (or vertical direction coordinates), and y may mean horizontal coordinates (horizontal direction coordinates) (e.g., the coordinates of a left-top sample within the prediction block may correspond to (0,0)). Dist(x,y,mode) may mean the distance between the prediction sample and a first reference sample according to an intra-prediction mode. Furthermore, max(block_size) may mean a larger value of M and N, assuming that the size of the prediction block is M×N.

Furthermore, α, β may be defined as weights applied to the prediction sample and a second reference sample. In this case, the weights α and β are α+β=1 and may satisfy α≥β. In this case, the weights α and β may be scaled and used as integers depending on implementation convenience.

A difference from Equation 1 is chiefly described. In Equation 1, a reference value that determines whether or not to perform filtering has been defined as a value of an offset of a given size added to the length of one side of a prediction block. In the present embodiment, however, a non-square prediction block is assumed. Accordingly, in Equation 8, a reference value that determines whether or not to perform filtering is defined as a value of an offset of a given size added to the length of a larger side among the lengths of sides of a prediction block (i.e., the width or height of the prediction block).

Accordingly, referring to Equation 8, when the distance between a prediction sample and a first reference sample is smaller than the length of a larger side among the lengths of a prediction block, filtering may not be applied. In contrast, when the distance between the prediction sample and the first reference sample is greater than or equal to the length of a larger side among the lengths of the prediction block, filtering may be applied.

If the filtering is applied, a filtered value may be calculated by applying the weight α to the prediction sample value P(x,y), applying the weight β to an added value of a second reference sample ref(x,−1) close to the prediction sample (i.e., a sample having the same vertical coordinates as the prediction sample) among reference samples neighboring the left of the prediction block (or current block) and a second reference sample ref(−1,y) close to the prediction sample (i.e., a sample having the same horizontal coordinates as the prediction sample) among reference samples neighboring the top of the prediction block, and adding values to which the weight α and the weight β have been respectively applied.

Furthermore, Equation 9 illustrates a filtering method in which a criterion for determining whether or not to perform filtering is an added value of the length of a smaller side in a prediction block (or current block) and an offset of a given size.

$$Filter ( P ( x , y ) ) = \{ \begin{matrix}P ( x , y ) , \\ Dist ( x , y , mode ) < min ( BLOCK\_SIZE ) + offset \\ α \cdot P ( x , y ) + β ( ref ( x , - 1 ) + ref ( - 1 , y ) ) , \\ Dist ( x , y , mode ) \geq min ( BLOCK\_SIZE ) + offset\end{matrix} \qquad [ Equation 9 ]$$

A difference from Equation 1 is chiefly described. In Equation 1, the reference value that determines whether or not to perform filtering has been defined as a value of an offset of a given size added to the length of one side of a prediction block. In the present embodiment, however, a non-square prediction block is assumed. Accordingly, in Equation 8, the reference value that determines whether or not to perform filtering is defined as a value of an offset of a given size added to the length of a smaller size among the lengths of sides of a prediction block.

Accordingly, referring to Equation 9, when the distance between a prediction sample and a first reference sample is smaller than the length of a smaller side among the lengths of a prediction block, filtering may not be applied. In contrast, when the distance between the prediction sample and the first reference sample is greater than or equal to the length of a smaller side among the lengths of the prediction block, filtering may be applied.

If the filtering is applied, a filtered value may be calculated by applying a weight α to a prediction sample value P(x,y), applying a weight β to an added value of a second reference sample ref(x,−1) close to the prediction sample among reference samples neighboring the left of the prediction block (or current block) and a second reference sample ref(−1,y) close to the prediction sample among reference samples neighboring the top of the prediction block, and adding values to which the weight α and the weight β have been respectively applied.

Furthermore, the criterion for determining whether or not to perform filtering may be flexibly changed depending on a prediction mode. For example, if an intra-prediction mode has been selected as a direction biased to verticality (i.e., when an prediction mode belongs to the No. 18 to 34 modes in the case of an intra-prediction mode of HEVC), the size of a prediction block is M×N, and M>N (i.e., a block having a width greater than a height), prediction samples whose distance from a first reference sample is smaller than M are relatively many or the distance of all the prediction samples may be smaller than M. Accordingly, in such a case, the length of one side of a prediction block used as the criterion for determining whether or not to perform filtering may be set as N not M.

Furthermore, when an intra-prediction mode is a direction biased to verticality, the size of a prediction block is M×N, and M<N (i.e., a block having a height greater than a width), if the length of one side of the prediction block used as a criterion for determining whether or not to perform filtering is set as M, the distortion of the prediction block may occur because a large number of prediction samples may be filtered if an offset is not great. Accordingly, in such a case, a smaller value of M and N may be selected.

Furthermore, a filtering range may be randomly adjusted through a method, such as that the size of an offset is limited using the size of a prediction block and prediction mode information. In other words, the range of a prediction sample to which filtering is applied may be adjusted by setting the size of an offset to a given size or more.

As described above, a method of flexibly changing a criterion for determining whether or not to perform filtering based on a prediction mode may be represented like Equation 10.

$$Filter ( P ( x , y ) ) = \{ \begin{matrix}P ( x , y ) , \\ Dist ( x , y , mode ) < criterion ( BLOCK\_SIZE , MODE ) + \\ offset \\ α \cdot P ( x , y ) + β ( ref ( x , - 1 ) + ref ( - 1 , y ) ) , \\ Dist ( x , y , mode ) \geq criterion ( BLOCK\_SIZE , MODE ) + \\ offset\end{matrix} \qquad [ Equation 10 ]$$

In this case, P(x,y) may mean a prediction sample value positioned in (x,y) within a prediction block. In this case, x may mean vertical coordinates, and y may mean horizontal coordinates (e.g., the coordinates of a left-top sample within the prediction block may correspond to (0,0)). Dist(x,y,mode) may mean the distance between the prediction sample and a first reference sample according to an intra-prediction mode.

Furthermore, α, β may be defined as weights applied to the prediction sample and a second reference sample. In this case, the weights α and β are α+β=1 and may satisfy α≥β. In this case, the weights α and β may be scaled and used as integers depending on implementation convenience.

A criterion (BLOCK_SIZE,MODE) may output an M or N value based on the size of a prediction block and a prediction mode when the size of the prediction block is M×N. As described above, the encoder/decoder may flexibly change the criterion for determining whether or not to perform filtering based on the size of a prediction block and a prediction mode. When a prediction block is a non-square block, a prediction error can be reduced by flexibly changing a criterion for determining whether or not to perform filtering.

Referring to Equation 10, if a filtering determination reference value is determined to be an added value of a criterion (BLOCK_SIZE,MODE) value and an offset of a given size, when the distance between a prediction sample and a first reference sample is smaller than the filtering determination reference value, filtering may not be applied. In contrast, when the distance between the prediction sample and the first reference sample is greater than or equal to the filtering determination reference value, filtering may be applied.

If the filtering is applied, a filtered value may be calculated by applying the weight α to the prediction sample value P(x,y), applying the weight β to an added value of a second reference sample ref(x,−1) closet to the prediction sample among reference samples neighboring the left of the prediction block (or current block) and a second reference sample ref(−1,y) closest to the prediction sample among reference samples neighboring the top of the prediction block, and adding values to which the weight α and the weight β have been respectively applied.

In this case, in order to apply the filtering, as illustrated in Equations 8 to 10, both the second reference sample ref(x,−1) on the left and the second reference sample ref(−1,y) at the top may be used. Unlike in the example of Equations 8 to 10, in order to apply the filtering, only the second reference sample ref(x,−1) on the left may be used or only the top second reference sample ref(−1,y) may be used.

Furthermore, the encoder/decoder may use only the left reference sample ref(x,−1) or may use only the top reference sample ref(−1,y) or may use both the left reference sample ref(x,−1) and the top reference sample ref(−1,y), as the second reference sample, based on an intra-prediction mode.

The distance between the prediction sample and the first reference sample may be calculated using a tan value and a tan \hat{ }(−1) value for the angle θ of a prediction mode because the tan value and the tan \hat{ }(−1) value may be previously determined as in Table 2 and Table 3 in order to identify the position of the first reference sample according to the angular prediction mode, for example.

In this case, the encoder/decoder may calculate the distance between the prediction sample and the first reference sample using the methods described in FIGS. 8 to 11.

In contrast, the encoder/decoder may table and refer to distance information on the position of the prediction sample for each block size and each prediction mode in order to simplify a procedure for calculating the distance between the prediction sample and the first reference sample.

Furthermore, as in the filtering method of Equation 10, the weighted sum of a current prediction sample and the second reference sample is represented, but each second reference sample used for filtering may be defined to have a weight according to the distance from the prediction sample. For example, this may be represented like Equation 11.

$$Filter ( P ( x , y ) ) = \{ \begin{matrix}P ( x , y ) , \\ Dist ( x , y , mode ) < criterion ( {BLOCK}_{SIZE} , MODE ) + \\ offset \\ α \cdot P ( x , y ) + β ( \frac{x}{b} \cdot ref ( x , - 1 ) + \frac{y}{b} \cdot ref ( - 1 , y ) ) , \\ Dist ( x , y , mode ) \geq criterion ( {BLOCK}_{SIZE} , MODE ) + \\ offset\end{matrix} \qquad [ Equation 11 ]$$

In this case, b may be previously defined as the width or height of the prediction block.

A difference from Equation 10 is chiefly described. Before the weight β is applied to the second reference samples in the vertical direction and horizontal direction, a weight may be applied to the second reference sample ref(x,−1) closet to the prediction sample among reference samples neighboring the left of the prediction block (or current block) as much as a value of the vertical coordinates x divided by b. Furthermore, a weight may be applied to the second reference sample ref(−1,y) closest to the prediction sample among reference samples neighboring the top of the prediction block as much as a value of the horizontal coordinates y divided by b.

As described above, a higher weight may be assigned to the second reference sample closer to the prediction sample when filtering is performed because a weight according to a distance from the prediction sample is applied to the second reference sample.

Furthermore, when the filtering is applied, only a second reference sample closest to the prediction sample may be used. For example, this may be represented like Equation 12.

$$Filter ( P ( x , y ) ) = \{ \begin{matrix}P ( x , y ) , \\ Dist ( x , y , mode ) < \\ criterion ( BLOCK\_SIZE , MODE ) + \\ offset \\ α \cdot P ( x , y ) + β \cdot ( ref ( i , j ) ) , \\ Dist ( x , y , mode ) \geq \\ criterion ( BLOCK\_SIZE , MODE ) + \\ offset\end{matrix} \\ where \\ i = \{ \begin{matrix}- 1 , & x < y \\ x , & x \geq y\end{matrix} \\ and \\ j = \{ \begin{matrix}- 1 , & x \geq y \\ y , & x < y\end{matrix} \qquad [ Equation 12 ]$$

A difference from Equation 1 is described. The size of the vertical coordinates x is compared with the size of the horizontal coordinates y. When x is greater than or equal to y, only the reference sample ref(x,−1) closest to the prediction sample among reference samples neighboring the left of the prediction block (or current block) may be used as the second reference sample. In contrast, when y is greater than x, only the reference sample ref(−1,y) closest to the prediction sample among reference samples neighboring the top of the prediction block may be used as the second reference sample.

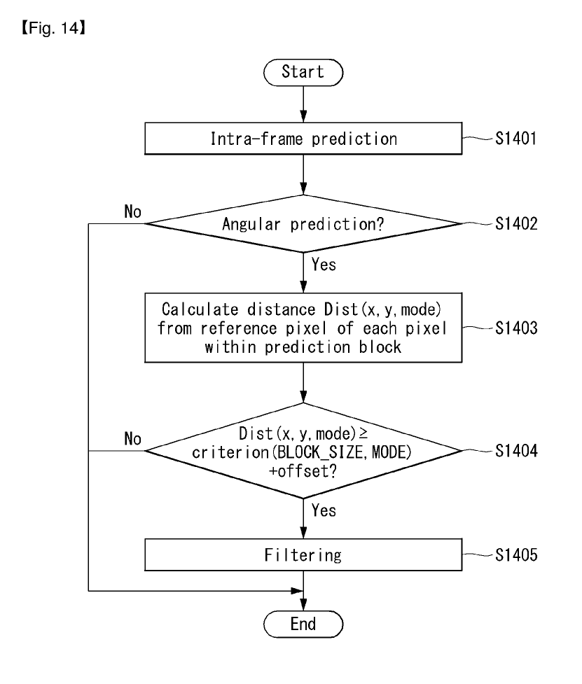

FIG. 14 is a diagram illustrating an intra-prediction method according to an embodiment of the present invention.

The encoder/decoder performs intra-frame prediction on a current processing block (S1401).

That is, a filtering method proposed in the present embodiment may be applied when intra-frame prediction is performed. First, the encoder/decoder may generate the prediction block of a current processing block (or current block) based on an intra-frame prediction mode. As described above, the encoder/decoder may derive an intra-frame prediction mode, and may duplicate a first reference sample value to a prediction sample within the prediction block based on the direction of the intra-frame prediction mode.

In this case, the encoder/decoder may apply the filtering method of the present embodiment in a block unit after it calculates a prediction sample value with respect to all samples within the current block (or prediction block) or may apply the present filtering method in a sample unit in a process of searching for each prediction sample within the current block (or prediction block).

The encoder/decoder determines whether the prediction mode of the current block is an angular prediction mode (S1402).

If, as a result of the determination in step S1402, the prediction mode of the current block is not an angular prediction mode (i.e., if the prediction mode is a non-angular prediction mode, such as Planar mode, a DC mode), the filtering method of the present embodiment may not be applied as described above.

In contrast, if, as a result of the determination in step S1402, the prediction mode of the current block is an angular prediction mode, the encoder/decoder calculates the distance between each sample (i.e., prediction sample) within the prediction block and the first reference sample (S1403).

In this case, the distance (Dist(x,y,mode)) between the prediction sample and the first reference sample may be calculated by the methods described in FIGS. 8 to 11. Furthermore, the distance may be calculated using a tan value and a tan \hat{ }(−1) value for the angle θ of the prediction mode because the tan value and the tan \hat{ }(−1) value may be previously determined as in Table 2 and Table 3 in order to identify the position of the first reference sample according to the angular prediction mode.

Furthermore, the encoder/decoder may table and refer to distance information on the position of the prediction sample for each block size and each prediction mode in order to simplify a procedure for calculating the distance between the prediction sample and the first reference sample.

The encoder/decoder determines whether the distance between the prediction sample and the first reference sample is greater than or equal to an added value (i.e., filtering criterion value) of a criterion (BLOCK_SIZE,MODE) value and an offset of a given size (S1404).

That is, the encoder/decoder may compare the value, calculated in step S1403, with the filtering criterion value in order to determine whether or not to apply filtering to the prediction sample.

As described above, the criterion (BLOCK_SIZE,MODE) may output an M or N value based on the size of the prediction block and the prediction mode when the size of the prediction block is M×N (i.e., may output the width or height of the prediction block). That is, the encoder/decoder may flexibly change the criterion for determining whether or not to perform filtering based on the size of the prediction block and the prediction mode. When the prediction block is a non-square block, a prediction error can be reduced by flexibly changing the criterion for determining whether or not to perform filtering.

Furthermore, as described above, the criterion for determining whether or not to perform filtering is determined to be a criterion (BLOCK_SIZE,MODE) value and an offset of a given size and described, but is not limited thereto.

As in the example of Equation 8, the criterion for determining whether or not to perform filtering may be defined as an added value of the length of a larger side of a prediction block (i.e., a greater value of the width and height) and an offset of a given size. As in the example of Equation 9, the criterion for determining whether or not to perform filtering may be defined as an added value of the length of a smaller side of the prediction block (i.e., a smaller value of the width and height) and an offset of a given size.

If, as a result of the determination in step S1404, the distance between the prediction sample and the first reference sample is smaller than the filtering criterion value, filtering may not be applied.

In contrast, if, as a result of the determination in step S1404, the distance between the prediction sample and the first reference sample is greater than or equal to the filtering criterion value, filtering is applied to the prediction sample (S1405).

As described in Equation 1, the filtering may be performed by applying weights to the prediction sample value and a second reference sample value close to the prediction sample, respectively, and combining them.

Furthermore, as described in Equation 11, the weighted sum of a current prediction sample and the second reference sample is represented, but each second reference sample used for filtering may be defined to have a weight according to a distance from the prediction sample. A higher weight may be assigned to the second reference sample closer to the prediction sample when filtering is performed by applying, to the second reference sample, the weight according to the distance from the prediction sample.

Furthermore, as described above, when the filtering is applied, only a second reference sample closest to the prediction sample among the second reference samples may be used.

The filtering method proposed in the present embodiment may be applied to a luma component sample or a chroma component sample.

Furthermore, as described above, after the prediction block is constructed based on the intra-prediction mode, post-processing filtering for reducing the discontinuity of the reference sample and a block boundary may be performed on a block predicted in a horizontal direction mode, a vertical direction mode or a DC mode. The filtering method of the present embodiment may be performed prior to the post-processing filtering or may be performed after the post-processing filtering.

### Embodiment 3

The present embodiment proposes a filtering method when reference is made to multiple reference sample lines (or multiple reference pixel lines) based on the contents of the embodiment 1 and the embodiment 2.

Assuming that an image (or picture) split in a raster scan order is encoded/decoded, left, left-top, top, right-top samples of a current block may already have been reconstructed.

In this case, the encoder/decoder may perform intra-frame prediction with reference to one line or multiple lines depending on a reference condition. This is described with reference to the following drawing.

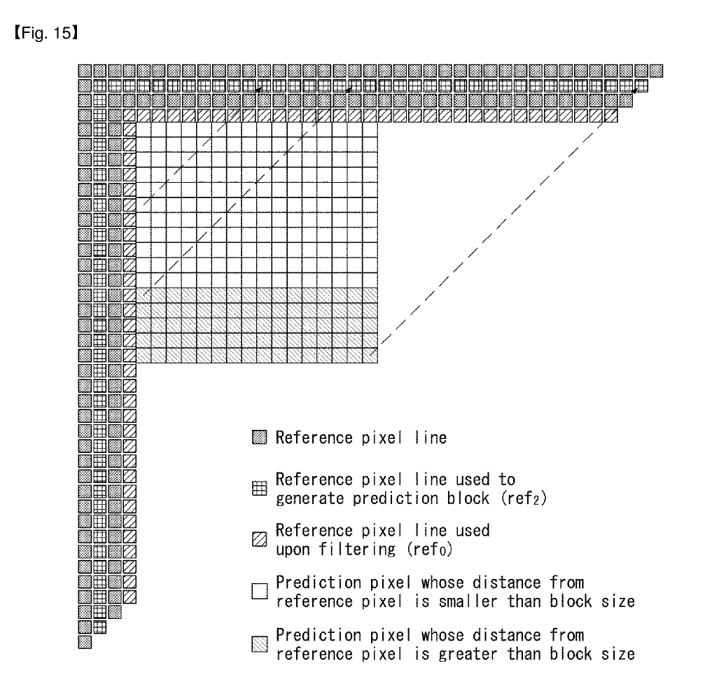

FIG. 15 is an embodiment to which the present invention may be applied and illustrates a filtering method when multiple reference samples are used.

Referring to FIG. 15, the encoder/decoder may generate a prediction block with reference to an optimal reference sample line (or reference pixel line) ref_2 having the smallest error among several reference sample lines (or reference pixel lines) neighboring a current block.

Hereinafter, in the description of the present invention, the optimal reference sample line ref_2 may mean a reference sample line having the smallest error when a prediction block is generated.

If the optimal reference sample line ref_2 is not a reference sample line ref_0 immediately neighboring the current block (or prediction block), the distance between a prediction sample and a second reference sample can be reduced using the most neighboring reference sample line ref_0 when filtering is performed.

Equation 13 illustrates a filtering method when reference is made to multiple reference sample lines.

$$Filter ( P ( x , y ) ) = \{ \begin{matrix}P ( x , y ) , \\ Dist ( x , y , mode ) < b + offset \\ α \cdot P ( x , y ) + β ( {ref}_{0} ( x , - 1 ) + {ref}_{0} ( - 1 , y ) ) , \\ Dist ( x , y , mode ) \geq b + offset\end{matrix} \qquad [ Equation 13 ]$$

As in the example of Equation 1, Equation 13 illustrates a filtering method when a criterion for determining whether or not to perform filtering is an added value of the length of one side of a prediction block (or current block) and an offset of a given size.

Equation 13 is described chiefly based on a difference from Equation 1. The second reference sample positioned in the reference sample line ref_0 most neighboring the current block (or prediction block) may be used for filtering.

When the distance between the prediction sample and a first reference sample is smaller than a filtering criterion value, filtering may not be applied.

In contrast, when the distance between the prediction sample and the first reference sample is greater than or equal to the filtering criterion value, filtering may be applied.

If the filtering is applied, a filtered value may be calculated by applying a weight α to a prediction sample value P(x,y), applying a weight β to an added value of a second reference sample ref_0(x,−1) closest to the prediction sample in ref_0 reference sample lines and a second reference sample ref(−1,y) closest to the prediction sample among the ref_0 reference sample lines, and adding values to which the weight α and the weight β have been respectively applied.

In this case, as described in the embodiment 1 and the embodiment 2, each second reference sample used for filtering may be defined to have a weight according to a distance from the prediction sample. Only a second reference sample closest to the prediction sample may be used when filtering is applied.

Furthermore, the encoder/decoder can compensate for the distance between the first reference sample and the prediction sample by performing filtering using a reference sample line (i.e., optimal reference sample line ref_2) used to generate the prediction block.

Furthermore, a reception stage (i.e., decoder) may analogize and use a reference sample line on which filtering will be performed in the same manner as a transmission stage (i.e., encoder) or may receive information regarding which reference sample line will be used for filtering from a transmission stage. In this case, the encoder/decoder may set the distance between the reference sample line used for filtering and a prediction block so that the distance is closer than or equal to the distance between the prediction block and a reference sample line used to generate the prediction block.

### Embodiment 4

The present embodiment proposes a different criterion for determining whether or not to perform filtering based on the contents of the embodiments 1 to 3.

Whether or not to perform a filtering method (hereinafter referred to as a “present filtering method”) proposed in the embodiments 1 to 3 may be determined based on the size of a block as follows.

The present filtering method may be applied only when the size of a block is greater than a randomly defined specific value.

The present filtering method may be applied only when the size of a block is smaller than a randomly defined specific value.

Information regarding whether the present filtering method will be applied in a block of which size may be received from a transmission stage (i.e., encoder).

The above criteria for determining whether to apply filtering may be individually applied and 2˜3 types of determination criteria may be combined and applied.

Furthermore, whether or not to apply the present filtering method may be determined based on a luma component and a chroma component as follows.

The present filtering method may be applied to only a luma component Y.

The present filtering method may be taken in both a luma component Y and chroma components (Cb, Cr).

Whether or not to apply the present filtering method may be determined based on a construction ratio of chroma components. For example, the present filtering method may be applied to only a luma component in 4:2:0 or 4:2:2, and the present filtering method may be applied to both a 4:4:4 luma component and chroma component.

Furthermore, the present filtering method may be applied in the case of various color formats in addition to YCbCr.

Furthermore, whether or not to apply the present filtering method may be determined based on an intra-frame prediction mode as follows.

The present filtering method may be variably applied depending on an intra-frame prediction mode. For example, if the intra-frame prediction mode is a vertical mode (i.e., No. 26 mode in the case of HEVC) or a horizontal mode (i.e., No. 10 mode in the case of HEVC), the present filtering method may not be applied.

Furthermore, for example, if the intra-frame prediction mode corresponds to four vertical peripheral modes (i.e., Nos. 24, 25, 27, 28 modes in the case of HEVC) or four horizontal peripheral modes (i.e., Nos. 8, 9, 11, 12 in the case of HEVC), the present filtering method may not be applied.

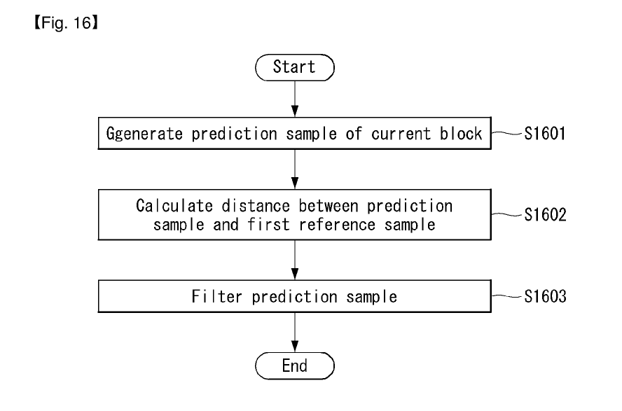

FIG. 16 is a diagram illustrating an intra-prediction method according to an embodiment of the present invention.

The encoder/decoder generates a prediction sample of a current block based on an intra-prediction mode of the current block (S1601).

As described in FIGS. 5 and 6, the encoder/decoder may derive the intra-prediction mode of the current block and construct reference samples to be used for prediction using samples neighboring the current block. Furthermore, if some of the samples neighboring the current block has not yet been decoded or is not available, the encoder/decoder may construct reference samples to be used for prediction by substituting unavailable samples with available samples. Furthermore, the encoder/decoder may perform filtering on the reference samples based on the intra-prediction mode. Furthermore, the encoder/decoder may generate the prediction sample of the current block based on the intra-prediction mode and the reference samples.

Furthermore, as described above, the encoder/decoder may apply a filtering method, applied in subsequent steps, in a block unit after it generates a prediction sample value with respect to all samples within the current block, and may apply the filtering method in a sample unit (i.e., pixel unit) in a process of searching for each prediction sample within the current block.

The encoder/decoder calculates the distance between the prediction sample and a first reference sample used to generate the prediction sample (S1602).

The encoder/decoder may calculate the distance between the prediction sample and the first reference sample using the methods described in FIGS. 8 to 11.

Furthermore, a tan value and a tan \hat{ }(−1) value for the angle θ of the prediction mode may be previously determined as in Table 2 and Table 3 in order to identify the position of the first reference sample according to an angular prediction mode. The encoder/decoder may calculate the distance between the prediction sample and the first reference sample using the tan value and the tan \hat{ }(−1) value.

In other words, the encoder/decoder may calculate the distance between the prediction sample and the first reference sample using the angle of the intra-prediction mode and the horizontal coordinates or vertical coordinates of the prediction sample.

Furthermore, when the direction of the intra-prediction mode is a negative angle direction (i.e., in the case of modes using an inverse angle), the encoder/decoder may calculate the distance between the prediction sample and the first reference sample based on the first reference sample positioned in a main reference sample array.

As described above, a left or reference sample array may mean a main reference sample array based on an intra-prediction mode. Specifically, in the case of a vertical mode (i.e., if a prediction mode belongs to the No. 18 to No, 25 modes) among the modes using an inverse angle, the top reference sample array may become a main reference sample array. In the case of a horizontal mode (i.e., if a prediction mode belongs to the No. 11 to No, 17 modes) among the modes using an inverse angle, the left reference sample array may become a main reference sample array.

In the vertical mode of the modes using an inverse angle, a prediction sample may be generated with reference to the top reference sample array (i.e., main reference sample array), but the inverse angle is used. Accordingly, a left reference sample in addition to a top reference sample may be used to generate a prediction sample. In this case, the top reference sample array (i.e., main reference sample array) may be extended because the left reference sample used to generate the prediction sample is added to the top reference sample array.

Likewise, in the horizontal mode of the modes using an inverse angle, the left reference sample array (i.e., main reference sample array) may be extended because the top reference sample used to generate the prediction sample is added to the left reference sample array.

Furthermore, the encoder/decoder may table and refer to distance information on the position of the prediction sample for each block size and each prediction mode in order to simplify a procedure for calculating the distance between the prediction sample and the first reference sample.

When the distance between the prediction sample and the first reference sample is greater than a filtering criterion value in step S1602, the encoder/decoder performs filtering on the prediction sample by weighted-summing at least one of a sample, having the same vertical coordinates as the prediction sample, among reference samples neighboring the current block and a sample, having the same horizontal coordinates as the prediction sample, among the reference samples and the prediction sample as a second reference sample (S1603).

As described in the embodiments 1 and 2, when the distance between the prediction sample and the first reference sample is greater than a given distance, the encoder/decoder can improve the accuracy of prediction by filtering the second reference sample close to the position of the prediction sample within the current block.

That is, the encoder/decoder may perform filtering on the prediction sample using the methods described in Equation 1, Equations 6 to 13.

Specifically, filtering may be applied when the distance between the prediction sample and the first reference sample is greater than or equal to the filtering criterion value. If the filtering is applied, a filtered value may be calculated by applying a weight to a prediction sample value, applying a weight to an added value of a second reference sample closest to the prediction sample (i.e., sample having the same vertical coordinates as the prediction sample) among reference samples neighboring the left of the prediction block (or current block) and a second reference sample closest to the prediction sample (i.e., sample having the same horizontal coordinates as the prediction sample) among the reference samples neighboring the top of the prediction block, and adding values to which the weights have been respectively applied.

Furthermore, as described above, the encoder/decoder represents the weighted sum of the current prediction sample and the second reference samples, but each second reference sample used for filtering may be defined to have a weight according to a distance from the prediction sample. Furthermore, the encoder/decoder may use only a second reference sample closest to the prediction sample when it performs filtering.

In this case, the filtering criterion value may be set as a value of an offset of a given size added to the length of one side of the current block (or width value of the current block) when the current block is a square block.

Furthermore, when the current block is a non-square block, the filtering criterion value may be set as a value of an offset of a given size added to the length of a larger side (a greater value of the width and height) among the lengths of the sides of the current block or the length of a smaller side (a smaller value of the width and height) among the lengths of the sides of the current block.

Furthermore, the filtering criterion value may be set as a value of an offset of a given size added to a value determined based on the size of the current block and the intra-prediction mode, among the width and height of the current block.

Furthermore, if the encoder/decoder uses multiple reference sample lines (or reference pixel lines) in order to perform intra-prediction, it can reduce the distance between the prediction sample and the second reference sample using the most neighboring reference sample line when it performs filtering.

Furthermore, the encoder/decoder can compensate for the distance between the first reference sample and the prediction sample by performing filtering using a reference sample line (i.e., optimal reference sample line) used when it generates the prediction block or a reference sample line closer than the reference sample line (i.e., optimal reference sample line).

Furthermore, a reception stage (i.e., decoder) may analogize and use a reference sample line on which filtering will be performed in the same manner as a transmission stage (i.e., encoder) or may receive information regarding which reference sample line will be used for filtering from the transmission stage. In this case, the encoder/decoder may set the distance between the reference sample line used for filtering and the prediction block so that the distance is closer than or equal to the distance between the reference sample line used for filtering and a reference sample line used to generate the prediction block.

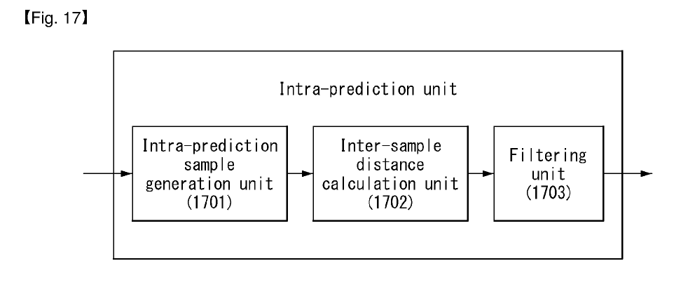

FIG. 17 is a detailed diagram illustrating an intra-prediction unit according to an embodiment of the present invention.

In FIG. 17, the intra-prediction unit has been illustrated as being one, for convenience of description, but the intra-prediction unit may be implemented as an element included in the encoder and/or the decoder.

Referring to FIG. 17, the intra-prediction unit implements the functions, processes and/or methods proposed in FIGS. 8 to 16. Specifically, the intra-prediction unit may be configured to include an intra-prediction sample generation unit 1701, an inter-sample distance calculation unit 1702 and a filtering unit 1703.

In FIG. 17, the inter-sample distance calculation unit 1702 and the filtering unit 1703 have been illustrated as being included in the intra-prediction unit, for convenience of description, but the inter-sample distance calculation unit 1702 and/or the filtering unit 1703 may be implemented as elements separated from the intra-prediction unit.

The intra-prediction sample generation unit 1701 may generate a prediction sample of a current block based on an intra-prediction mode of the current block.

As described in FIGS. 5 and 6, the intra-prediction sample generation unit 1701 may derive the intra-prediction mode of the current block and construct reference samples to be used for prediction using samples neighboring the current block. Furthermore, if some of the samples neighboring the current block has not yet been decoded or is not available, the intra-prediction sample generation unit 1701 may construct reference samples to be used for prediction by substituting unavailable samples with available samples. Furthermore, the intra-prediction sample generation unit 1701 may perform filtering on the reference samples based on the intra-prediction mode. Furthermore, the intra-prediction sample generation unit 1701 may generate the prediction sample of the current block based on the intra-prediction mode and the reference samples.

Furthermore, as described above, the intra-prediction sample generation unit 1701 may apply the filtering methods proposed in the embodiments 1 to 3 in a block unit after it calculates a prediction sample value with respect to all samples within the current block, and may apply the filtering methods in a sample unit in a process of searching for each prediction sample within the current block (or prediction block).

The inter-sample distance calculation unit 1702 may calculate the distance between a prediction sample and a first reference sample used to generate the prediction sample.

In this case, the inter-sample distance calculation unit 1702 may calculate the distance between the prediction sample and the first reference sample using the methods described in FIGS. 8 to 11.

Furthermore, a tan value and a tan \hat{ }(−1) value for the angle θ of the prediction mode may be previously determined as in Table 2 and Table 3 in order to identify the position of the first reference sample according to an angular prediction mode. The inter-sample distance calculation unit 1702 may calculate the distance between the prediction sample and the first reference sample using the tan value and the tan \hat{ }(−1) value.

In other words, the inter-sample distance calculation unit 1702 may calculate the distance between the prediction sample and the first reference sample using the angle of the intra-prediction mode and the horizontal coordinates or vertical coordinates of the prediction sample.

Furthermore, when the direction of the intra-prediction mode is a negative angle direction (i.e., in the case of modes using an inverse angle), the inter-sample distance calculation unit 1702 may calculate the distance between the prediction sample and the first reference sample based on the first reference sample positioned in a main reference sample array.

As described above, a left or top reference sample array may mean a main reference sample array based on an intra-prediction mode. Specifically, in the case of a vertical mode (i.e., if a prediction mode belongs to the No. 18 to No, 25 modes) among the modes using an inverse angle, the top reference sample array may become a main reference sample array. In the case of a horizontal mode (i.e., if a prediction mode belongs to the No. 11 to No, 17 modes) among the modes using an inverse angle, the left reference sample array may become a main reference sample array.

In the vertical mode of the modes using an inverse angle, a prediction sample may be generated with reference to the top reference sample array (i.e., main reference sample array), but the inverse angle is used. Accordingly, a left reference sample in addition to a top reference sample may be used to generate a prediction sample. In this case, the top reference sample array (i.e., main reference sample array) may be extended because the left reference sample used to generate the prediction sample is added to the top reference sample array.

Likewise, in the horizontal mode of the modes using an inverse angle, the left reference sample array (i.e., main reference sample array) may be extended because the top reference sample used to generate the prediction sample is added to the left reference sample array.

Furthermore, the inter-sample distance calculation unit 1702 may table and refer to distance information on the position of the prediction sample for each block size and each prediction mode in order to simplify a procedure for calculating the distance between the prediction sample and the first reference sample.

When the distance between the prediction sample and the first reference sample is greater than a filtering criterion value, the filtering unit 1703 may perform filtering on the prediction sample by weighted-summing at least one of a sample, having the same vertical coordinates as the prediction sample, among reference samples neighboring the current block and a sample, having the same horizontal coordinates as the prediction sample, among the reference samples and the prediction sample as a second reference sample.

As described in the embodiments 1 and 2, when the distance between the prediction sample and the first reference sample is greater than a given distance, the filtering unit 1703 can improve the accuracy of prediction by filtering the second reference sample close to the position of the prediction sample within the current block.

That is, the filtering unit 1703 may perform filtering on the prediction sample using the methods described in Equation 1, Equations 6 to 13.

Specifically, filtering may be applied when the distance between the prediction sample and the first reference sample is greater than or equal to the filtering criterion value. If the filtering is applied, a filtered value may be calculated by applying a weight to a prediction sample value, applying a weight to an added value of a second reference sample closest to the prediction sample (i.e., sample having the same vertical coordinates as the prediction sample) among reference samples neighboring the left of the prediction block (or current block) and a second reference sample closest to the prediction sample (i.e., sample having the same horizontal coordinates as the prediction sample) among the reference samples neighboring the top of the prediction block, and adding values to which the weights have been respectively applied.

Furthermore, as described above, the filtering unit 1703 represents the weighted sum of the current prediction sample and the second reference samples, but each second reference sample used for filtering may be defined to have a weight according to a distance from the prediction sample. Furthermore, the filtering unit 1703 may use only a second reference sample closest to the prediction sample when it performs filtering.

In this case, the filtering criterion value may be set as a value of an offset of a given size added to the length of one side of the current block (or width value of the current block) when the current block is a square block.

Furthermore, when the current block is a non-square block, the filtering criterion value may be set as a value of an offset of a given size added to the length of a larger side (a greater value of the width and height) among the lengths of the sides of the current block or the length of a smaller side (a smaller value of the width and height) among the lengths of the sides of the current block.

Furthermore, the filtering criterion value may be set as a value of an offset of a given size added to a value determined based on the size of the current block and the intra-prediction mode, among the width and height of the current block.

Furthermore, if the filtering unit 1703 uses multiple reference sample lines (or reference pixel lines) in order to perform intra-prediction it can reduce the distance between the prediction sample and the second reference sample using the most neighboring reference sample line when it performs filtering.

Furthermore, the filtering unit 1703 can compensate for the distance between the first reference sample and the prediction sample by performing filtering using a reference sample line (i.e., optimal reference sample line) used when it generates the prediction block or a reference sample line closer than the reference sample line (i.e., optimal reference sample line).

Furthermore, the filtering unit 1703 may analogize and use a reference sample line on which filtering will be performed in the same manner as a transmission stage (i.e., encoder) or may receive information regarding which reference sample line will be used for filtering from the transmission stage. In this case, the filtering unit 1703 may set the distance between the reference sample line used for filtering and the prediction block so that the distance is closer than or equal to the distance between the reference sample line used for filtering and a reference sample line used to generate the prediction block.

In the aforementioned embodiments, the elements and characteristics of the present invention have been combined in specific forms. Each of the elements or characteristics may be considered to be optional unless otherwise described explicitly. Each of the elements or characteristics may be implemented in such a way as to be not combined with other elements or characteristics. Furthermore, some of the elements and/or the characteristics may be combined to form an embodiment of the present invention. The order of the operations described in connection with the embodiments of the present invention may be changed. Some of the elements or characteristics of an embodiment may be included in another embodiment or may be replaced with corresponding elements or characteristics of another embodiment. It is evident that an embodiment may be configured by combining claims not having an explicit citation relation in the claims or may be included as a new claim by amendments after filing an application.

The embodiment of the present invention may be implemented by various means, for example, hardware, firmware, software or a combination of them. In the case of implementations by hardware, an embodiment of the present invention may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers and/or microprocessors.

In the case of an implementation by firmware or software, an embodiment of the present invention may be implemented in the form of a module, procedure, or function for performing the aforementioned functions or operations. Software code may be stored in memory and driven by a processor. The memory may be located inside or outside the processor, and may exchange data with the processor through a variety of known means.

It is evident to those skilled in the art that the present invention may be materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### INDUSTRIAL APPLICABILITY

The aforementioned preferred embodiments of the present invention have been disclosed for illustrative purposes, and those skilled in the art may improve, change, substitute, or add various other embodiments without departing from the technological spirit and scope of the present invention disclosed in the attached claims.

1. A method of processing video based on an intra-prediction mode, the method comprising:
generating a prediction sample of a current block based on an intra-prediction mode of a current block;
calculating a distance between the prediction sample and a first reference sample used to generate the prediction sample; and
performing filtering on the prediction sample by weighted-summing at least one of a sample having same vertical coordinates as the prediction sample and a sample having same horizontal coordinates as the prediction sample, among reference samples neighboring the current block, and the prediction sample as a second reference sample when the distance between the prediction sample and the first reference sample is greater than a filtering criterion value.

2. The method of claim 1,
wherein when the current block is a square block, the filtering criterion value is set to a value obtained by adding an offset of a predetermined size to a width value of the current block.

3. The method of claim 1,
wherein when the current block is a non-square block, the filtering criterion value is set to a value obtained by adding an offset of a predetermined size to a greater value among a width and height of the current block.

4. The method of claim 1,
wherein when the current block is a non-square block, the filtering criterion value is set to a value obtained by adding an offset of a predetermined size to a smaller value among a width and height of the current block.

5. The method of claim 1,
wherein when the current block is a non-square block, the filtering criterion value is set to a value obtained by adding an offset of a predetermined size to a value determined according to a size of the current block and the intra-prediction mode, among a width and height of the current block.

6. The method of claim 1,
wherein a sample positioned in a distance closer to the prediction sample, among the sample having the same vertical coordinates as the prediction sample and the sample having the same horizontal coordinates as the prediction sample, is determined as a second reference sample.

7. The method of claim 1,
wherein the filtering is performed by applying, to the second reference sample, a weight based on a distance between the prediction sample and the second reference sample.

8. The method of claim 1,
wherein the distance between the prediction sample and the first reference sample is calculated using an angle of the intra-prediction mode and the vertical coordinates or horizontal coordinates of the prediction sample.

9. The method of claim 8,
wherein when a direction of the intra-prediction mode is a negative angle direction, the distance between the prediction sample and the first reference sample is calculated based on the first reference sample positioned in a reference sample array neighboring a top or left of the current block.

10. The method of claim 1,
wherein the distance between the prediction sample and the first reference sample is derived from a predetermined distance between the prediction sample and the reference sample based on a size of the current block and the intra-prediction mode.

11. The method of claim 1,
wherein when reference is made to multiple reference sample lines in order to generate the prediction sample of the current block, the filtering is performed using a second reference sample positioned in a reference sample line most neighboring the current block.

12. The method of claim 1,
wherein when reference is made to multiple reference sample lines in order to generate the prediction sample of the current block, the filtering is performed using a second reference sample positioned in a reference sample line used to generate the prediction sample or a reference sample line more neighboring the current block than the reference sample line used to generate the prediction sample.

13. The method of claim 1,
wherein when reference is made to multiple reference sample lines in order to generate the prediction sample of the current block, a reference sample line in which the second reference sample used for the filtering is positioned is transmitted from an encoder.

14. An apparatus for processing video based on an intra-prediction mode, the apparatus comprising:
a prediction sample generation unit configured to generate a prediction sample of a current block based on an intra-prediction mode of a current block;
an inter-sample distance calculation unit configured to calculate a distance between the prediction sample and a first reference sample used to generate the prediction sample; and
a filtering unit configured to perform filtering on the prediction sample by weighted-summing at least one of a sample having same vertical coordinates as the prediction sample and a sample having same horizontal coordinates as the prediction sample, among reference samples neighboring the current block, and the prediction sample as a second reference sample when the distance between the prediction sample and the first reference sample is greater than a filtering criterion value.
